(19) United States
(12) Patent Application Publication
(10) Pub. No.: US 2010/0250424 A1
(43) Pub. Date: Sep. 30, 2010

(54) Method and System combining a Social Network Service with an Alternative Trading System and Electronic Communication Network to produce entertainment media

(76) Inventor: Adam Torres, Piermont, NY (US)

Correspondence Address: Adam Torres, 109 Abbottsford Gate, Piermont, NY, 10968, US

(21) Appl. No.: 12/411,319

(22) Filed: Mar. 25, 2009

(51) Int. Cl. G06Q 40/00; G06Q 99/00; G06Q 50/00

(52) U.S. Cl. 705/37; 705/319

(57) ABSTRACT

A Method and System combining a Social Network Service with an Alternative Trading System and Electronic Communications Network to produce entertainment media. The application can be used in a myriad of ways, from a social point of view and a financial one, to assist in the creation of the independent producer's art.

### FEDERALLY SPONSORED RESEARCH

Not Applicable

### SEQUENCE LISTING OR PROGRAM

Not Applicable

### BACKGROUND

1. Field

This Application relates to entertainment media production and more specifically, how to finance the production and distribution of entertainment media products.

2. Prior Art

Any discussion of the prior art throughout the specification should in no way be considered as an admission that such prior art is widely known or forms part of common general knowledge.

The major studio/distributors in Hollywood, divisions of the major global media conglomerates (NBC Universal, Sony, Viacom/CBS, Disney/ABC, Time Warner Bros., News Corp/Fox) who supply over 90% of media content to the U.S.A thru monopolistic control of the industry by employing the Cartel (a formal organization of producers that agree to coordinate prices and production) like use of unfair, unethical, anti-competitive, predatory and illegal business practices, including provisions in the distribution deal between film distributors and producers. These unconscionable and some say illegal business practices are used to control a majority of the media industry to the detriment of the United States because the majority of the ideas produced in Hollywood are self-serving corporate visions used to maintain control of this vital medium for the exchange of information. A free and open society depends on a myriad of views to remain a growing democracy.

The Entertainment Media Industry including; Major Motion Pictures, Independent Films, Television Content, Web/TV Content, News, Video Games, Music, Theater, Literature, Periodicals and other forms of entertainment media that are known now or in the future will in this document be called Hollywood.

Major studio/distributors have taken a basic economic advantage—that of a favorable law of supply and demand—and manipulated it and exploited it for 100 years. It has gotten to the point where there is no merit system left in Hollywood.

It is important to recognize that he who controls the money in Hollywood also controls the right to choose which movies are produced and released, who gets to work on those movies at the highest levels and the actual content of those movies. Thus, the economic dominance of the major studio/distributors, gained and maintained through the use of unfair, unethical, anti-competitive, predatory and illegal business practices, is also responsible for the employment discrimination that occurs daily in the Hollywood-based U.S. film industry and the patterns of bias seen in Hollywood films.

Now, what does this have to do with democracy? Well, the fundamental concepts of democracy and freedom of speech, the very freedom enjoyed by feature film and other media in our society, go hand-in-hand. They are both based on the underlying principle of a free market place of ideas. In other words, the drafters of our Constitution determined many years ago, that our nation would be more likely to make the best democratic decisions with respect to important issues that face our country if all viewpoints are heard—if everyone in our society has a fair opportunity to express their views.

Now, our national discourse is dominated by the ideas that are communicated through the mass media. One significant medium for communication of ideas in our society is feature film. To the extent that this important indications medium is not equally and fairly open to all groups within our diverse society for the expression of their views, our free market place of ideas is severely limited and our democracy is substantially weakened.

The accumulated history of Hollywood reveals a pattern in the way Hollywood insiders interact with outsiders. They welcome them for a time, allow them to participate in the making of movies to a limited degree, encourage them to spend as much money within the industry as possible, and then, when the outsider discovers that a lot more money has been spent than has been made, the outsider bows out. This pattern has repeated itself throughout the history of the Hollywood-dominated U.S. movie industry and thrives today. This insider/outsider phenomenon is vital to understanding what is really going on in Hollywood- for understanding how insiders (the Oligarchy) gained and maintain their control over the Hollywood-based U.S. film industry.

The proposition that it is not in the best interest of the United States or the world for any single, or even a few narrowly defined interest groups (no matter whether such groups are defined in terms of religion, race, culture, ethnicity, region or nation of origin, sex or sexual orientation or other arbitrary characteristics), to dominate or control any of our significant communication media.

The entire U.S. population and the people of the world have suffered great loss due primarily to the fact that the U.S. film industry is controlled by people who place a greater emphasis on controlling the creative process, communicating the messages they approve (as opposed to the messages of others) and making huge amounts of money, than on allowing filmmakers to more freely express themselves through film. The tragedy of the U.S. film industry's failure to help creator's express more and varied visions through movies detracts from our democracy.

Members of the Hollywood control group have long been hiding behind the protection of the free-speech provision of the First Amendment or Constitution to Patent communicate whatever its members want in films, while at the same time, using other means including employment discrimination and anticompetitive business practices to prevent others from telling their important stores, and communicating their ideas through film.

Faced with intractable social or commercial obstacles in the attempt to exercise their art, it is time for everyone to realize that great film making artists should not have to change in order to “work in the Hollywood studio system” but that this cartel like a defective system should be economically disrupted and replaced with an industry that values creativity and diversity and an industry that is not divided between insiders and outsiders.

The Hollywood-based U.S. film industry (which is dominated by a small number of major studio/distributors) has developed a litigation strategy that, for all practical purposes, removes the lawsuit as an effective remedy of such wrong doing. It Makes it difficult to organize the creative community today because most of the people working in Hollywood are intimidated by the major studios and are so concerned about their own careers that few if, any, are willing to take the necessary steps to bring about long-term, lasting reform in the film industry. Hollywood is a company town.

Unless the Hollywood outsider groups are able to work together in a coordinated effort to bring down the power of the Hollywood insiders nothing will change. Only if power is shared more equitably can change be realized.

The Sherman Antitrust Act of Jul. 2, 1890, ch. 647, 26 Stat. 209, 15 U.S.C 1-7) was the first United States Federal statute to limit cartels and monopolies. It falls under antitrust law.

The Act is brief and not highly specific. This meant that responsibility for the development of Anti-Trust law was entrusted to the U.S. courts, particularly the Supreme Court, which have the power to interpret federal statutes.

Section 1 of the Act prohibits “agreements, conspiracies or trusts in restraint of trade,” making them a crime. Not every alleged agreement is treated alike. The Court has interpreted this section to prohibit arrangements that unreasonably manipulate trade, differentiating between two kinds of conduct: agreements which are very likely to raise costs to consumers, and those which might, but were not highly likely to be harmful.

A trust is a centuries old form of a contract whereby one party entrusts their property to a second party. The property is then used to benefit the first party. In a corporate trust, the various corporations assign their stock to a board of trustees. The trust then issues trust certificates to the stockholders. They receive the financial benefits, while, the board of trustees maintain operational control. By consolidating control of most companies in an industry under one controlling board, the industry is essentially monopolized.

Around the world, what U.S. lawmakers and attorneys call “Antitrust” is more commonly known as “competition law.” The purpose of the act was to oppose the combination of entities that could potentially harm competition, such as monopolies or cartels. Its reference to trusts today is anachronism. At the time of its passage, the trust was synonymous with monopolistic practice, because the trust was a popular way for monopolists to hold their businesses, and a way for cartel participants to create enforceable agreements.

The Sherman Act was not specifically intended to prevent the dominance of an industry by a specific company, despite misconceptions to the contrary. According to Senator George Hoar, an author of the bill, any company that “got the whole business because nobody could do it as well as he could” would not be in violation of the act. The law attempts to prevent the artificial raising of prices by restriction of trade or supply. In other words, innocent monopoly, or monopoly achieved solely by merit, is perfectly legal, but acts by a monopolist to artificially preserve his status, or nefarious dealings to create a monopoly, are not.

The Act provides: “Every contract, combination in the form of trust or otherwise, or conspiracy, in restraint of trade or commerce among the several States, or with foreign nations, is declared to be illegal”. The Act also provides: “Every person who shall monopolize, or attempt to monopolize, or combine or conspire with any other person or persons, to monopolize any part of the trade or commerce among the several States, or with foreign nations, shall be deemed guilty of a felony”. The Act puts responsibility upon government attorneys and district courts to pursue and investigate trusts, companies and organizations suspected of violating the Act. The Clayton Act (1914) extended the right to sue under the antitrust laws to “any person who shall be injured in his business or property by reason of anything forbidden in the antitrust laws.” Under the Clayton Act, private parties may sue in U.S. district court and should they prevail, they may be awarded treble damages and the cost of suit, including reasonable attorney's fees.

The Clayton Act of 1914 made both substantive and procedural modifications to federal antitrust law. Substantively, the act seeks to capture anticompetitive practices in their incipiency by prohibiting particular types of conduct, not deemed in the best interest of a competitive market. There are 4 sections of the bill that proposed substantive changes in the antitrust laws by way of supplementing the Sherman Act of 1890. The Act was an attempt to define more clearly the basic policy of the United States with respect to the organization and control of the industry.

The Federal Trade Commission (FTC) is an independent agency of the United States government established in 1914 by the Federal Trade Commission Act. Its principal mission is the promotion of “consumer protection” and the elimination and prevention of what regulators perceive to be harmfully “anti-competitive” business practices, such as coercive monopoly.

Since its inception, the FTC has enforced the provisions of the Clayton Act, a key anti-trust statute, as well as the provisions of the FTC Act, 15 U.S.C 41 et seq. Over time, the FTC has been delegated the enforcement of additional business regulation statutes and has promulgated a number of regulations (codified in Title 16 of the Code of Federal Regulations).

The Bureau of Competition is the division of the FTC charged with elimination and prevention of “anticompetitive” business practices. It accomplishes this through the enforcement of antitrust laws, review of proposed mergers, and investigation into other non-merger business practices that may impair competition. Such non-merger practices include horizontal restraints which involve agreements between direct competitors, and vertical restraints, again involving agreements among businesses at different levels in the same industry (such as suppliers and commercial buyers).

The FTC shares enforcement of antitrust laws with the Department of Justice. However, while the FTC is responsible for civil enforcement of antitrust laws, the Antitrust Division of the Department of Justice has the power to bring both civil and criminal action in antitrust matters.

The Federal Trade Commission is headed by five Commissioners who are nominated by the President and confirmed by the United States Senate.

At a minimum, it would appear that the congress and federal agencies of the United States have negligently avoided their oversight and regulatory responsibilities with regard to the implementation of U.S. laws relating to employment discrimination and competition in the marketplace (anti-trust laws), specifically as such laws are supposed to be applied to the U.S. film industry. At the other extreme, it may be fair to argue that years of enormous political contributions to U.S. Presidents, key members of Congress and Los Angeles District Attorneys have effectively negated both the federal government and the DA's office as factors in the Hollywood game. Thus, until someone in such a position decides to take on the Hollywood establishment, it may actually be accurate to say that there really are no rules in Hollywood; since it seems no one has accepted the responsibility of enforcing the rules that currently exist.

Relationships are essential to getting anything done. Hollywood is an industry built on relationships. What exactly is a “relationship business?” It is an industry in which business choices and decisions relating to whether business should be conducted with certain other individuals or entities based to a great extent on some affinity, link, affiliation or association which may or may not be directly related to the nature of the business. In this sense, such relationship choices might be viewed as another barrier to entry in any of the acquisition, development, production, distribution and/or exhibition levels of the motion picture business.

Thus, success in Hollywood, in most instances, does not depend on merit but on establishing agreeable personal relations with people who can help you.

Engaging in reciprocal preference in a business context (i.e., mutual partiality among competing businesses) may in some instances be a violation of the U.S. antitrust laws (see Section 1 of the Sherman Antitrust Act). In addition, another reasonable interpretation of the “business of relationships” concept is that Hollywood has, in many instances, substituted relationships for merit, and, at the same time, placed severe and arbitrary restrictions on who is allowed to have those key relationships.

Players do business within a limited group of Hollywood insiders and the entire system has evolved to allow these insiders to take talent, projects and money from outsiders, without letting those outsiders ultimately retain control over their own projects for any long-term period.

The importance of the reciprocal preferences in Hollywood—“the club takes care of its own and protects itself”. The club is made up of team players who routinely engage in a series of reciprocal preferences with each other to the exclusion of outsiders. This, of course, makes it more difficult for outsiders to compete (i.e. it is an anti-competitive business practice).

The accumulated history of Hollywood reveals a pattern in the way Hollywood insiders interact with outsiders. It seems they welcome them for a time, allow them to participate in the making of movies to a limited degree, encourage them to spend as much money within the industry as possible, and then, when the outsider discovers that a lot more money has been spent than has been made, the outsider usually bows out. This pattern has repeated itself throughout the history of the Hollywood—dominated U.S. movie industry and thrives today. This insider/outsider phenomenon is vital to understanding what is really going on in Hollywood-for understanding how insiders gained and maintain their control over the Hollywood-based U.S. film industry.

Hollywood insiders want to use other peoples' money to produce and release the films they choose with as few strings attached as possible and insist on retaining as much discretion as possible regarding how much of that money flows through the distributors to others.

If the history of Hollywood holds true, once outsiders are deemed to be direct competitive threats to the major studio/distributors, various tactics will be used to shorten their stay in the industry. In addition, such outsiders will be criticized in the Hollywood trade press and in books written by authors who are friendly to Hollywood insiders. Those books will be published by publishing companies either owned by the same corporate conglomerates that own the major studio/distributors or by publishing companies owned or staffed by individuals who are on friendly terms with Hollywood insiders. That's the method used in Hollywood.

Outsiders work on both the creative and the management/ownership sides of the Hollywood-based U.S. film business. A review of the better known outsiders (D. W. Griffith, Joseph P. Kennedy, William Randolph Hearst, Orson Wells, Howard Hughes, Kirk Kerkorian and David Putnam) of the Hollywood studio system reveals a consistent pattern: they were victims of discrimination and predatory business practices directed toward them by the Hollywood insiders.

Hollywood outsiders were denied access to the vertically integrated studio/distributors theatres whenever possible, and if a film was shown on a screen controlled by the major studio/distributors, so called “accounting problems” occurred. In those days as today the major studio/distributors controlled many of the key theatres.

The studio's considerable amount of control over exhibition in key theatres used that power to arbitrarily exclude films from the marketplace thus preventing competition to succeed. Creative control and accounting for films' proceeds are the other main problems that independent producers consistently encounter in their dealings with the major studio/distributors of Hollywood.

Discriminatory and predatory business practices, accounting problems at the distributor or exhibitor level at theaters owned or controlled by rival vertically integrated film companies fit the pattern that was ultimately proscribed in the subsequent Paramount consent cases that used the Sherman Anti-Trust Act and the Clayton Act to prosecute the anti-competitive business practices used by the Hollywood studios.

United States v. Paramount Pictures, Inc., 334 US 131 (1948) (also known as the Hollywood Antitrust Case of 1948, the Paramount Case, the Paramount Decision or the Paramount Decree) was a landmark United States Supreme Court anti-trust case that decided the fate of movie studios owning their own theatres and holding exclusivity rights on which theatres would show their films. It would also change the way Hollywood movies were produced, distributed, and exhibited. The Court held in this case that the existing distribution scheme was in violation of the antitrust laws of the United States, which prohibit certain exclusive dealing arrangements.

The major film studio/distributor's owned the theaters where their motion pictures were shown, either in partnerships or outright and complete. Thus specific theater chains showed only the films produced by the studio that owned them. The studios created the film's, had the writers, directors, producers and actors on staff (“under contract” as it was called), owned the film processing and laboratories, created the prints and distributed them through the theaters that they owned: In other words, the studios were vertically integrated, creating a de facto oligopoly. By 1945, the studios owned either partially or outright 17% of the theaters in the country, accounting for 45% of the film-rental revenue.

Ultimately, this issue of the studios' unfair trade practices would be the reason behind all the major movie studios being sued in 1938 by the U.S. Department of Justice. Coincidentally, the Society of Independent Motion Pictures a group led by Mary Pickford, Walter Wagner, and others filed a lawsuit against Paramount Detroit Theaters in 1942, the first major lawsuit of producers against exhibitors.

The federal government's case, filed in 1938, was settled with a consent decree in 1940, which allowed the government to reinstate the lawsuit if, in three years' time, it had not seen a satisfactory level of compliance. Among other requirements, the consent decree included the following conditions: (1) The Big Five studios could no longer block-book short film subjects along with feature films (known as one-shot, or full force, block booking); (2) the Big Five studios could continue to block-book features, but the block size would be limited to five films; (3) blind buying (buying of films by theater districts without seeing films beforehand) would now be outlawed and replaced with “trade showing,” special screenings every two weeks at which representatives of all 31 theater districts in the United States could see films before they decided to book a film; and (4) the creation of an administration board to enforce these requirements. The film industry did not satisfactorily meet the requirements of the consent decree, forcing the government to reinstate the lawsuit-as promised-three years later, in 1943. The case went to trial—with now all of the Big Eight as defendants—on Oct. 8, 1945, months after the end of World War 2.

The case reached the U.S. Supreme Court in 1948. The verdict went against the movie studio/distributors, forcing all of them to divest themselves of their movie theater chains. In addition to Paramount, RKO Pictures, Loews, Twentieth Century Fox, Columbia Pictures, Universal Pictures, Warner Bros., the American Theatres Association and W. C. Allred were named as defendants.

The Paramount Case is a bed-rock of corporate anti-trust law, and as such is cited in most cases where issues of vertical integration play a prominent role in restricting fair trade.

How do the major entertainment media conglomerates illegally control Hollywood today? They do it thru quiet cooperation and collusion in the Hollywood executive suites.

Studio executives just ignore the Paramount decision and United States laws. Today potential block-buster films are used to persuade exhibitors to not only exhibit the star vehicle but to also agree to exhibit other films from the same distributor that do not contain stars or feature lesser known actors and actresses, in effect, a slightly modified version of block booking which is illegal under the Sherman Anti-Trust Act and the Paramount consent decree but it is still pervasive and although should still be regulated according to the law is in reality not to any large extent. This flies in the face of the law and shows how powerful the Hollywood insider community is.

Block booking also prevents independent producers and distributors from gaining access to the theater screens desired by the major studios distributors. The practice also has an adverse effect on the quality of films that are available.

The tie-in is what is illegal. In other words, in order for the practice to be considered illegal, the exhibitors would have to be told, or at least these distributors would have to be shown to have implied, that if the exhibitor wanted one of the films in the group, it would also have to rent one or more of the others. Another way of stating the practice, is to point out that if the distributors refused to break up the groups of pictures referred to, then block booking was occurring.

This is the essence of the blockbuster strategy, or the new form of block booking. Each of the major studios will always try to come up with one, two or three great films each year that will give the studio enough leverage with the exhibitors to, at least subtly, coerce the exhibitors and take the studios weaker product that year to the exclusion of the independently distributed films. These hoped-for blockbusters will always have some of the biggest stars who require the most amount of money and only the major studios can pay such star salaries; hence, only the major studios/distributors can routinely utilize the blockbuster strategy.

The major studios/distributor policy towards blockbusters actually rises to the level of a deliberate competitive strategy and the very essence of the strategy is anticompetitive in nature i.e. it was originally designed and has continued to present the smaller, less powerful independent producers and distributors from getting their films exhibited at the vast majority of the available desirable theaters. The prospective blockbuster film has become part of the modern day block booking.

The blockbuster strategy of the major studios/distributors appears to be nothing more than a slightly modified, more subtle and more difficult to prove form of block booking. In addition talent agency packaging is nothing more than block booking which is just as illegal.

Upper management at the major studio/distributors seems to change often, which creates certain problems in and of itself. One of the reactions of the Hollywood insiders club to this ongoing executive shuffle is to play a game of musical chairs. The various upper-level studio management, agents, attorneys and independent producer positions generally are being exchanged among members of the Hollywood insider club, effectively foreclosing opportunities to other persons (i.e. those who are not Hollywood insiders). Thus the musical chairs phenomenon appears to be another means of maintaining control of the film industry for the Hollywood insiders club. The revolving-door phenomenon among agents and studio executives tends to facilitate a high level of cooperation or collusion between them.

As part of the game, independent producer relationships and reciprocal preferences between agents, lawyers and others who become studio executives quite often move on to independent producing, where many of them make even more money as a part of the system.

One of the specific tactics the Hollywood insiders use to protect their own is the independent producer consolation prize for the ousted studio executive. Typically, when an executive at a studio steps down or is pushed out, the studio gives said executive a consolation prize . . . an overall production deal in many instances, these independent production deals are actually more lucrative than the studio executive's compensation package. Thus, such deals ensure that the studio executive will not write a Hollywood insider's expose and embarrass the community. Such deals may thus be properly characterized as bribes.

In February of 2009 Peter Chernin resigned as President and Chief Officer of News Corporation the parent company of the Fox film studios after failing to agree to a new contract with his boss Rupert Murdoch. He had been Mr. Murdoch's man in Hollywood extending the media mogul's tentacles far beyond his traditional news paper business and establishing Fox as a powerhouse in filmmaking and broadcasting in the United States.

Mr. Chernin's consolation prize is one of the most gilded parachutes in Hollywood, and he will be floating into a new movie and television deal with Fox with the most favorable terms possible and with the studio promising to buy at least two movies per year from Chemin.

On Feb. 5, 2009 News Corp. missed quarterly earnings and the media giant swung to a fiscal second-quarter loss of $6.4 billion, the stock also dropped 40% since the beginning of the year.

The U.S. Securities and Exchange Commission voted in January of 2006 to force publicly held corporate conglomerates to more fully disclose their executive compensation packages in an effort to cut back on the lucrative deals hidden in the footnotes to corporate balance sheets. Reportedly reacting in part to the anger that led to an investor lawsuit against Disney, the SEC proposed a number of changes aimed at making it harder to disguise payments as stock options, perks and other benefits. In, 2004, investors took Disney to court over a $140 million compensation package paid to Disney executive Michael Ovitz, who only stayed at the company for about a year.

The Disney board was sued again by former Walt Disney director Roy Disney in 2005 seeking to void the company's last board election. Roy Disney claimed that investors were misled about the search for a successor to chief executive Michael Eisner. Roy Disney and another former Director, Stanley Gold, say the board promised an open search when it already had decided to elevate company President Robert Eiger. The Disney board of directors promised a search to sway the two men from running an alternate slate against the board. Roy Disney and Gold contend the company and its board promised a careful and thorough search for Eisner's successor as CEO while secretly rigging the process in favor of Eiger.

It is rumored that Mr. Murdoch wants his son James to succeed him and eventually become chairman of the publicly owned News Corp., even though he has no Hollywood experience. Another source close to the company said the elder Murdoch could do worse than to buy out transatlantic indie producer-distributor ShineReveille from NBC/Universal and put that company's head, who happens to be his daughter Elisabeth, in the top slot.

Hollywood's fondness for nepotism and conflicts of interest can contribute to the high cost of film production. Again, who loses in that situation? The stockholders, because of the money siphoned off from the revenue stream by the studio executives, talent and agents: the talent who cannot compete for certain jobs because they are not represented by the right power players; and movie going audiences because they are paying higher ticket prices to see movie deals on the screen opposed to better and more diverse films.

Studio executives high salaries traditionally paid the studio management are effectively amortized as costs of production (in some cases as part of the studio overhead charge) and since such costs of production are recouped by the studio out of each film's revenue streams, each company's shareholders or other investors are ultimately having to pay for such salaries. These are the same shareholders who are coerced into keeping the Hollywood insider management by means of the ever present threat of the studio executive mass exodus.

Studio executive's compensation packages often include performance bonuses insuring that much of the windfall blockbuster revenues will be siphoned off by the studio executives themselves and will not get to the studio's shareholders. Without the excessive studio executive and talent compensation, there would be few if any financial losers.

Studio executives want people to believe that the high cost of talent is the main culprit. Talent points back at the high salaries of the studio executives. The truth is that more than half of most films budgets are associated with management and talent part of which is shared with the agents that represent talent and the entertainment attorneys who document the deals.

The cost of talent associated with the production of films also has been excessive from the early days of Hollywood. Much of the high costs of film production stem from what is referred to in Hollywood as front-end-loading by talent.

The concept describes the efforts of stars, directors, producers, and other creative personnel, in studio, bank or investor financed films, who demand higher compensation to be paid at earlier stages of production or at earlier stages of the revenue stream, thus making less revenue available for the subsequent profit participants. Of course, one of the primary reasons such demands are being made is the pervasive distrust of the accounting procedures of the major studio/distributors. Another reason such demands are made is that the agents want their percentage as soon as possible.

The studios suggest that market forces determine the price of talent. As long as there is a limited amount of talent and strong demand for that talent is a matter of simple economics that their prices would go up. However, they conveniently overlook the fact that the studios, by and large, determine who the movie stars are, through their selection of individuals to publicize and promote, and in other instances, that some of the more powerful agents will threaten to take their talent packages elsewhere if a studio does not play ball. That does not sound like a free market. In reality there is not a small amount of talent in Hollywood, just feigned perception among the studio executives that only a small number of stars can successfully open their movies.

We have all seen and enjoyed actors who are not on the A-list that perform extremely well at opening movies sometimes even better than a star studded studio block buster which often times fail due to among other things miscasting which can occur when agents demand and get their way to package talent on the same film which does not enable the producer to make their own selection of who would best suit certain roles in the production.

The industry also overlooks the fact that these extremely high salaries for talent really reveal huge amounts of money are being made with feature films that the agents know this, and they know that much of that money is being siphoned off by the studio executives. So, in reality there is a competitive struggle occurring between agents (partly on behalf of their clients and partly on behalf of themselves) and the studio executives, to see who can retain the bigger part of film earnings, while the financial interests of minority (sometimes even majority) studio shareholders and others without much clout in Hollywood, get lost in the shuffle.

Furthermore, neither the salaries for the studio executives nor talent are determined in a free market. They are determined in a market dominated by a small group of major players, who have taken steps over the years to guarantee that no other companies can compete at the same level. And these major players engage in a series of reciprocal preferences to make sure they (the Hollywood insiders) reap most of the financial rewards from the exploitation of stars and films, to the exclusion of all others.

The salaries and compensation packages paid to the top studio executives, agents, actors, actresses and directors are far more than is needed to entice the most talented among them to perform the services they are asked to perform (so long as no one else is being paid more); thus, there have to be other reasons why such amounts are so high, and those reasons include a high concentration of power in the hands of a few studio executives and agents, along with the abuse of that power.

Feature films do not need to cost as much as they do, but the cost of producing American films, particularly those produced by the major studio/distributors has always been high. As reported by the MPAA (Motion Picture Association of America), the average cost to make and market an MPAA film was $96.2 million in 2005. This includes $60 million in negative costs and $36.2 million in marketing costs. Another result of the high cost of production is that such cost pressures have raised the barriers of entry into the business.

In addition, if the waste associated with the star system can be reduced, more opportunities for non-star actors will likely open and independent producers may get more chances to produce more diverse films (without star names) for audiences throughout the world. Unfortunately, the movies without stars often get squeezed out of the marketplace by the movies with the stars regardless of the relative merits of the films and because the major studio/distributors own the theaters.

Another important tactic the Hollywood insiders use to maintain their control of the industry is the threat of the mass exodus. This tactic allows the insiders' group to permit outside ownership of a major studio/distributor (organized as a corporation) without actually relinquishing control to one or more outsiders who actually have majority ownership. In other words, underlying all transactions between the entrenched traditional Hollywood management and outside owners is the threat that if the outsider does not go along with the advice and counsel of management, management will leave the studio en masse, leaving the outsider ownership with a shell corporation, with little capability to function in a community still controlled by Hollywood insiders, most of whom will support the ousted regime as opposed to an outsider-controlled studio.

These experiences, suggest that if a corporate conglomerate owner of a motion picture studio does not permit the traditional Hollywood management to control the company in most important respects, the management team will leave, or threaten to leave, en masse and take their critically important relationships with the creative community with them, thus leaving the old company as a mere shell unable to attract talent for it's pictures. In addition, the company's relationships with others in the insider community will also become strained. Thus, the valuable reciprocal preferences commonly extended between Hollywood insider-controlled major studio/distributors would no longer be available. The old company is thus doomed to fail, or at least have a more difficult time of it.

It isn't just that the Hollywood musical chairs phenomenon tends to exclude other qualified people from participating at the highest levels in the film industry. Another problem is that this practice breeds conflict of interest.

In addition, any independent producer utilizing the services of an entertainment attorney must have to wonder whether that attorney is going to be a film producer or a studio executive next year and thus effectively compete with his or her former client. This constant movement back and forth between and among the studios and other segments of the industry does create numerous conflict of interest opportunities, which many in the industry are unaware of or seem to completely disregard in their quest for fame and fortune.

Similar conflicts occur when agents move to studios as executives. That was part of the concern when CAA's Michael Ovitz helped to convince the French bank Credit Lyonnais to pump millions back into the ailing MGM operation. The studio part of the deal was that they hired former CAA agents as top executives.

Conflict of interest situations also arise in which a single film distributor plans to release more than one film at or about the same time, thus dividing the time, skill and efforts of the distributor's marketing staff between such films. This is not that much of a problem on the production costs if both films were provided by the studio. But when one of the films was produced by an independent producer without studio money, there is a risk that the distributor will not be as conscientious and the release of the independently produced film e.g. in allowing for adequate separation release dates between one of its own films and the independent producers films. For that reason the independent producer's film is not likely to receive the marketing support it would ordinarily receive.

The Board of Directors of the major studio/distributors also face a potential conflict of interest in declaring corporate dividends. Dividends represent a distribution of corporate profits as earnings to the corporation's shareholders, prorated by class of security and paid in the form of money, stock or company products or property.

When the top-level executives i.e. management of the corporation are able to control the votes of the Corporation's Board of Directors which is often the case in the film industry, they may be able to successfully siphon off more of the Corporation's revenue stream for their own compensation as opposed to allowing a larger amount of such corporate revenue to flow through to the corporate shareholders. This is exactly what occurs with respect to the high salaries of the top major studio/distributor executives, who in turn routinely complain about the high pressure and cost of some movies, mainly as a smokescreen so that shareholder attention can be diverted from the in-house part of the cost problem.

Agents also create conflicts of interest in seeking to arrange financing for their film projects. Variety's John Brodie report in September 1994 that the three biggest talent agencies ICM, CAA, and William Morris were chasing fractionalized movie finance deals for their client directors in a big way. As Brodie reports such deals involved co-financing outside the United States with offshore investors. Obviously, if agents are engaged in film financing activities, and get a piece of that action, they can no longer merely look out for any single clients best interests. Further, they are again encroaching on the professional responsibilities of producers.

So screenwriters, directors, actors or producers who seek a development deal at a major Hollywood studio/distributors have quite a slim chance. Every year the major studio/distributors and financiers put approximately 2000 film projects into development with only about 250 being produced, thus the effect of putting a film into development at a major studio/distributor is, in most cases, to simply take if off the market. Some in the industry actually accuse the studios from time to time of intentionally acquiring rights to certain projects, just to eliminate the competition of a project that is similar to one already in development, without, of course, informing those tied to the doomed project.

On top of that an estimated 25-35% of studio films come from scripts picked up in turnaround (when one studio sells another studio the rights to a project that studio owns). This suggests two things: (1) nobody in Hollywood really knows what is going to work at the box office, and (2) the studios effectively function as sources of development for each other, thus adding support for the contention that they function as an illegal cartel.

The details of these turnaround transactions are rarely available for review by outside parties; thus, again, they afford the studios an opportunity to shift monies back and forth between them, without public or government scrutiny. The effect suggests that the major studios actually function as a unit in the marketplace, as opposed to all other entities in the field. Or, the alternative, they compete with each other on different terms than they compete with industry outsiders. The turnaround system provides another opportunity to discriminate against unfriendly outside management and to favor friendly insider management. Thus, it appears that the major studio/distributors routinely engage in a series of reciprocal preferences with each other, with the turnaround transaction being but one of the possible vehicles for engaging in such favoritism.

Packaging is the process of assembling several creative elements director-producer or star or any combination with the screenplay offered to a financing source in order to enhance the transaction.

Packaging is not actually maligned because it places a certain pressure on potential buyers. Rather it is maligned because it is illegal. It is clearly a prohibited tie in that violates the federal and state antitrust laws. Furthermore even though the larger agencies have an advantage over smaller agencies because of their wider talent pool from which to choose, the studio executive or independent producer who refuse to accept agency package deals would have an even larger talent pool from which to select, since they would not be limited to just the clients of a single agency, large or small the effect of not packaging a movie would likely be positive, because the actors are more likely to be chosen on their merits, not on the basis of which agency represents them.

Agency packaging is unfair to the studios has anticompetitive effects on other talent agencies can have an anticompetitive effect of certain actors, actresses, directors, producers and screenwriters i.e. those who cannot be chosen to work on a given film, simply because they are not represented by the right agency and ultimately harms the movie going public by forcing fewer talented actors into certain roles, merely because the agency wants them in the package for financial reasons. Strangely enough, no one is effectively challenging the practice. The vast majority of people in the film industry are desperately protecting their future career opportunities and do not want to rock the boat.

Agencies get away with packaging because none of the studio executives, competing agencies, independent producers or creative people complain. Either all of them hope they will benefit from the agency package at one level or another, or they realize that if they complain i.e. make an antitrust law-based claim against the compelling agency etc., such litigation will be expensive, time-consuming, may or may not result in victory for the complaint because all litigation is risky, and in the meantime, would most assuredly compromise the ability of the complaining individual to function within the Hollywood insider community in a negative way.

In addition, the studios that might also be in a position to complain don't, partly because their executives tend to be former agents. In any case the results of agency packaging do not directly harm the studio executives whose interest are seldom the same as the interest of the studio shareholders also, actors or actresses only rarely complain about the practice.

Agency packaging appears to be at the heart of a very corrupt system, perpetuated by Hollywood insiders. It is extremely difficult to fight. It may require US Justice Department investigation. On the other hand Hollywood invests so much money into the Presidential campaigns of both Republican and Democratic candidates that it is difficult to get an administration to act on it.

Such stories, which are not uncommon, serve to illustrate how a system of reciprocal preferences among Hollywood insiders effectively excludes others from the fruits of their labors and keeps motion picture production cost so high.

Considering the above, the high costs of Hollywood productions would not be necessary in a truly competitive marketplace and the high salaries paid by Hollywood are not purely a function of such a marketplace. Such high salaries are specifically designed and used (1) to shift a substantial portion of the major studio/distributor revenues to the studio executives and agents: (2) as a way to keep those persons who are not studio executives and agents under control and quiet about what goes on in Hollywood; (3) to eliminate the ability of independent production companies (both in the U.S.-based and foreign) to fairly compete with the major studio/distributors and (4) as an extremely high barrier to keep other potential competitors from entering the field.

Studios can try to protect themselves by developing projects in-house rather than relying on the agents to present them with a fully formed package of script, star and director. And they can also try to hedge their bets by offering a star or director share of the box office takes in return for modest payment up front. Of course, it is extremely difficult for major studio/distributor to get any knowledgeable star or director to accept a net profit participation in lieu of salary up front today, since such contingent compensation is widely believed to have little chance of materializing, due primarily to the contract drafting, accounting and contract interpretation of the major studio/distributors themselves.

Some of the Hollywood players are participating at an even higher level, where the studios themselves are bought and sold. The money involved at that level is staggering. For example, in “May, 1981 . . . MGM (paid) . . . some $380 million to acquire United Artists—a company, that by all accounts, was in deep trouble. Then, in late 1989, the Japanese conglomerate Sony, overpaid Columbia . . . some 3.4 billion, also assuming $1.4 billion in long-term debt.” In addition, Sony found itself sandbagged into paying as much as $600 million for the right to hire the producing team of Peter Guber and Jon Peters as heads of production at Columbia.. Guber and Peters barely a year earlier had been willing to pay Kirk Kirkorian $100 million for the right to head MGM. Now Sony would have to allot some $600 million to hire the same two executives, an action that gave new meaning to the word inflation.

When you analyze such transactions, the importance of the Hollywood insider/outsider game becomes more apparent. After all, when individuals or companies—like Sony, Transamerica, Coca Cola, Howard Hughes, Kirk Kerkorian, Matsushita, Credit Lyonnais, etc. (all of whom were Hollywood outsiders) come to Los Angeles looking to make such a purchase and to hire the right people to manage their huge investment, they have to rely (as noted earlier) on the advice and counsel of Hollywood insiders with whom they have relationships for advice.

Not surprisingly, that advice steers the big money people to other Hollywood insiders, which makes the insider community happy. In those rare occasions in which the big studio buyers have opted to go against the advice of Hollywood insiders and brought in other outsiders to run the studios, the Hollywood insider community has been less than cooperative, thus making it exceedingly difficult for the studio and new regime to succeed. Ultimately, the Hollywood outsiders have had to sell the studio to stop its losses.

The studio/distributor's “sue us” strategy is a rampant tool used in Hollywood to keep control. Attorneys in preparation for the Buchwald V. Paramount case collected dozens of so-called standard form net profit contracts that the seven major studios had used over the past 20 years. They looked for identical language in each contract to see just how much one studio tracked another in drafting its agreements. The lawyers came up with 35 clauses that were virtually identical in every contract. His comparative charts showed that Paramount's concept of gross and net distribution fees and overhead were precisely the same in the business affairs departments at Universal, Columbia TriStar, MGM/UA, Warner Bros., Disney and 20th Century Fox—right down to the percentage point. Whenever one studio makes a change in the contract to disadvantage net profit participants, the others follow suit.

The motion picture studios are steadfast in their refusal to negotiate and modify, in any material or significant respect, the terms and provisions of their net profit participation agreements. If writers, producers and other talent wanted to do business with the studio, they had to accept the studio standard form profit participation agreement. Paramount standard form net profit participation contract is in its essential terms identical or virtually identical to the standard form contracts used by other motion picture studios. Thus, creative talent has no choice in terms of obtaining a different one with a more favorable definition of net profits at another studio.

The Buckwald court in Buckwald V. Paramount observed that the evidence indicated that Paramount's net profit formula is a film industry standard and that similar negotiations are conducted by other studios. The court also stated that it had evidence that once the studio develops a revision of the net profit formula, the other studios adopt that revision. These findings hint at possible collusion among the studios in setting the terms of the net profit formula.

“In virtually every film where artists, directors or writers are promised a percentage of the net or the gross, a dispute arises in which auditors have to be called in to see what fell into the cracks. Lawyers and accountants say every studio in town appears to have trouble with arithmetic.” Art Buchwald

One reason for this is that many actors, actresses, directors, producers and screenwriters who are either net or gross profit participants are already involved with the same studio or another major studios/distributor on their next film before they realize that the studio may be failing to properly account for their interest in net or gross profits. Thus, many of those people simply choose not to challenge the studios bookkeeping, because of the reasonable fear that such a challenge might interfere with their ongoing working relationship with the studio. A relative few choose to use so-called self-help methods by holding back their services on a future project that the studio wants, until the studio straightens out accounting. Few people have that kind of leverage, however.

Still others might choose to audit the studio. But, even then, after the audit is completed and it is determined that the studios did not properly account for its revenues which is typically the case, the auditor can only make a demand on behalf of his or her profit participation client against the studio. The studio typically will admit some mistakes, miscalculations or contract misinterpretations all of which favored the studio, but then offers some round—dollar amount that is far smaller than what should have been paid. The profit participant has an opportunity to obtain some money but not nearly as much as is actually due and, typically, must agree not to litigate and not to talk about the transaction as part of the settlement.

If the profit participant instead chooses to sue the studio, the expensive litigation process will very likely be drawn out over a 5 to 6 year period of time and eventually, just prior to trial, the distributor will make another settlement offer. Again, this settlement will be far below what is really owed, and the profit participant again has an opportunity to receive some money but an amount that is not nearly as much as should have been paid.

If the profit participant settles, the settlement agreement, again, will include a gag order, so that the profit participant cannot publicly complain about how he or she has been treated. If, on the other hand, the profit participant chooses to go to trial, it is much more likely that he or she will be effectively blacklisted in Hollywood i.e. the profit participant will discover that it is much more difficult to find work.

This appears to be a long-established pattern with respect to how the film industry's major studios/distributors handle litigation. Of course, the studios also do everything they can to prolong the time it takes to litigate such claims and they are typically in a much better position to finance such protracted lawsuits than the plaintiff. In addition, the studios receive some benefit from being able to use the profit participant's money during the course of the lawsuit: Thus, there is little reason for studios not to pursue such a strategy with respect to litigation.

Director Brian de Palma claims that “part of doing business in this community is that you normally have to litigate to collect money owed you”. The studio doesn't care if there's a lawsuit. Studios are sued all the time. The studios consider it a cost of doing business.”

Adding to the difficulty for prospective plaintiffs is that it is extremely difficult to find an experienced litigation attorney who will take such cases on a contingency fee basis without at least requiring the plaintiffs to fund all of the cost of such litigation. Thus, the prospective plaintiff will not only have to pay for the services of the profit participant lawyer, but he or she will also be required to pay for court costs, deposition fees, court reporters, experts, copying and so forth. Most people are simply not in the position to do that.

The “sue us” strategy goes like this, the studios know that if they hire an actor for nine million dollars, including profit percentage, and pay him I million, and that actor sues, and they settle for 2 million, that studio has saved 7 million. It's clearly financially worthwhile for them to do business that way on a regular basis.

Another entertainment litigator theorizes “let's say a big star signs a contract to do a picture and was owed 7 million. If the studio paid 3 million, and the star had to sue to collect the other 4 million, it would take five years to get to trial. During that time, the studio would use the interest on the star's money to pay attorney fees, and even if the star collected 100% of what they were owed, the studio would still be ahead.

To further illustrate the attitude of studio executives toward litigation, it was reported that at a time prior to the Buckwald lawsuit against Paramount, Art Buckwald told his friend, Paramount communications Inc., Chairman Martin Davis, what had happened to him and of his intention to sue the studio. Davis responded by sending the writer a bottle of champagne and a record of a song titled “Sue me”.

Paramount actually accused Buckwald of plagiarism and racism in the course of the lawsuit. This is an example of how far the studios will go when they are sued and the plaintiff actually goes all the way to court. This is also one of the reasons not many people sue, and those that do, settle out of court before the case actually goes to trial.

Art Buckwald said that in virtually every film where artists, directors or writers are promised a percentage of the net or the gross a dispute arises in which auditors have to be called in to see what fell thru the cracks. Lawyers and accountants say every studio in town appears to have trouble with arithmetic. Ironically, few of the cases, even though they involve millions of dollars in profits, actually get to court. They're mostly arbitrator settled.

Profit participation disputes remain commonplace. Artists routinely audit the books of companies they work for, looking for discrepancies in accounting that may mean that hundreds of thousands, even millions, of dollars owed them have been overlooked.

Arguments in the auditing of the films focus not on production cost, but rather on the revenue and expense sides of distribution. From that producer's perspective the expense of suing a distribution company can be staggering, even if the producer spread the cost of suing with other profit participants, studios have no reason to see matters adjudicated with any dispatch. They are unwilling to have their accounting practices and contract definitions dragged into the bright light of a courtroom. Far better from the studio standpoint is to delay as long as possible, using their deep pockets, and ultimately at the 11th hour to settle. This has been a pattern of disagreements with studios virtually since actors, directors and producers first gain profit participations in films.

The modus operandi of studios is to delay payments as long as possible so they have the use of the money. They have these huge legal departments so it is cheaper for them not to pay and get sued instead. Eventually they will settle. Thus it appears that an important part of the major studios/distributor scheme to separate many gross and net profit participants from their money is for such prospective plaintiffs to sue in order to get paid, even a small part of the amount owed. This can be fairly characterized as an abuse of the nation's system of justice, and the top-level studio executives, agents, and profit participation lawyers are all quite aware of it.

One of the effects of the studio's approach to handling the profit participations of the creative investor communities is the development of a unique industry in Los Angeles called profit participation accounting. Some seven or eight boutique accounting firms have sprung up over the years solely for the purpose of representing actors, actresses, directors, writers, producers, investors and others in these profit participation disputes, these firms specialize in auditing the books of film, television and music distributors because all seem to suffer from the same math related deficiencies. Profit participation statements typically do not add up correctly, and all the mistakes seem to be in favor of distributors. If this were not the case, there would be no need for these profit participation accounting firms.

In accountancy, Hollywood accounting is the practice of distributing the profit earned by a large project to corporate entities which, though technically distinct from the one responsible for the project itself, are typically owned by the same people. This has the net result of reducing the project's reported profit by a substantial margin, sometimes eliminating it altogether. This is most often done to reduce the amount which the corporation must pay in royalties or other profit sharing agreements.

Hollywood accounting gets its name from the alleged frequent practice of it in the entertainment industry—that is, in the movie studios of Hollywood. Stereotypically the creators of material which is adapted into screenplays fall victim to Hollywood accounting.

Hollywood accounting can take several forms. In one form, a subsidiary is formed to perform a given activity and the parent entity will extract money out of the subsidiary not in forms of profits but in the form of charges for certain “services.” The specific schemes can range from the simple and obvious to the extremely complex.

Three main factors in Hollywood accounting reduce the reported profit of a movie, and all have to do with the calculation of overhead:

Production overhead—Studios, on average, calculate production overhead by using a figure around 15% of total production costs. Distribution overhead—Film distributors typically keep 30% of what they receive from movie theaters (“gross rental”). Marketing overhead—to determine this number, studios usually determine about 10% of all advertising costs.

All of the above means of calculating overhead are highly controversial, even within the accounting industry. Namely, these percentages are assigned without much regard to how, in reality, these estimates relate to actual overhead costs. In short, this method does not, by any rational standard, attempt to adequately trace overhead costs.

Due to Hollywood accounting, it has been estimated that only about 5% of movies officially show a net profit, and the “losers” include such blockbuster films as Rain Man, Forrest Gump, Who Framed Rodger Rabbit, and Batman, which all took in huge amounts at the box-office and video sales.

All of this shows why so many big-name actors insist on “gross points” (a percentage of the gross revenue) rather than net profit participation. The saying in Hollywood is “a percentage of the net is a percentage of nothing.” This practice reduces the likelihood of a project showing a profit, as a production company will claim a portion of the reported box-office revenue was diverted directly to gross point participants.

For example; Winston Groom's price for the screenplay rights to his novel Forrest Gump included a share of the profits; however, due to Hollywood accounting, the film's commercial success was converted into a net loss, and Groom received nothing. That being so, he has refused to sell the screenplay rights to the novel's sequel, stating that he cannot in good conscience allow money to be wasted on a failure.

The film My Big Fat Greek Wedding was considered hugely successful for an independent film yet according to the studio, the film lost money. Accordingly, the cast (with the exception of Nia Vardalos who had a separate deal) sued the studio for their part of the profits. The original producers of the film have sued Gold Circle Films due to Hollywood accounting practices because the studio has claimed the film lost $20 million.

According to his publisher's website, fantasy novelist Peter S. Beagle is owed a substantial amount of money by Granada Media International, the current owner of the animated movie based on Beagle's book The Last Unicorn. Beagle's contract entitles him to 5% of the net profits of animated property, and 5% of the gross revenue from any film-related merchandising. Granada apparently claims the movie cost more to make than it took in, that it earned no money between 1986 and the acquisition of it in 1999, and the compounded interest on the loss adds up to several times what it cost to make. Beagle is currently attempting to raise funds to challenge Granada in court.

Hollywood accounting is not limited to movies. An example is Warner Brother's television series Babylon 5 created by J. Michael Straczynski, who wrote 90% of the episodes in addition to producing the show and would have received a generous cut of profits if not for Hollywood accounting. The series, which was profitable in each of its five seasons from 1993-1998, has garnered more than US$1 billion for Warner Brothers, most recently US$500 million in DVD sales alone. But in the last profit statement given to Straczynski, Warner Brothers claimed the property was $80 million in debt. “basically,” says Straczynski, “by the terms of my contract, if a set on a Warner Brothers movie burns down in Botswana, they can charge it against Babylon 5's profits.

Buckwald V. Paramount (1990) was a breach of contract lawsuit filed and decided in California in which humorist and writer Art Buchwald alleged that Paramount Pictures stole his script idea and turned it into the 1988 movie Coming to America. Buckwald won the lawsuit and was awarded damages, and then accepted a settlement from Paramount before any appeal took place.

The decision was important mainly for the courts determination in the penalty phase of the trial that Paramount used “unconscionable” means of determining how much to pay authors. Paramount claimed, and provided accounting evidence to support the claim, that despite the movies US$350 million in revenues, it had earned no net profit, according to the definition of “net profit” in Buchwald's contract, and hence Buckwald was owed nothing: a classic example of Hollywood accounting. The court agreed with Buckwald's argument that this was “unconscionable”, and therefore invalid.

Fearing a loss on appeal and, presumably, a wave of lawsuits by authors claiming they, too, had been wronged by the unconscionable net profit formula, Paramount settled with Buckwald for an undisclosed amount of money. As part of the settlement, the “unconscionable” decision was vacated.

Eddie Murphy was reportedly paid an “$8 million . . . acting fee” for staring in Coming to America, and “that didn't include his 15% of the gross profits and $5 million of ‘overhead’ charged to the picture, an astronomical sum in light of the combined salaries of the rest of the cast: $906,000” Approximately one-third of (the film's) . . . $39-million budget went to Eddie Murphy productions.

The court went out of its way to avoid criticizing Eddie Murphy, who, it said in its holding, was a “creative genius just as Buckwald was, and the fault in the whole matter lay with Paramount.

Hollywood accounting has long been derided as a cynical attempt by movie studios to cheat individual authors and net profit participants out of royalty payments. The accounting formulas used by the studios have allegedly been designed specifically to ensure that it is almost mathematically impossible for any movie to show a net profit. Specifically, the net profit formulas used in authors' contracts does not correspond to the net profit formula of generally accepted accounting principles (GAAP) that the movie studios use when creating their financial statements that are reported to the U.S. Securities and Exchange Commission and to the investing public. The “unconscionable” formula in the authors' contracts effectively double-counts many costs borne by the studios.

As a prime example, Warner Bros. was sued for firing a whistleblower in October 2003, a computer financial systems specialist Ruben Mellado at Warner sued Warner Bros. claiming the company wrongfully fired him after he blew the whistle on errors he found on profit participation statements on 140 films, including the 1973 horror classic The Exorcist. His lawsuit alleges that Warner's profit participation statements were a fraud on profit participants.

Unfortunately, people in the film industry generally do not complain too loudly about the business practices discussed because of the quite reasonable fear of being blacklisted. In other words, if producers, directors, actors, actresses and others who work in the motion picture industry complain or sue a distributor because of the MPAA company business practices described without being willing to settle for a round dollar amount far less than what might have otherwise been paid, it is very likely that such a person will soon find themselves without much work in the film community “you'll never work in this town again.” That too is an effective form of Hollywood blacklist.

Blacklisting has often been a contemptible consequence of litigating against the major studio/distributors. People who file lawsuits against the major studio/distributors and refused to accept a minimum settlement offer before trial are routinely blacklisted in the film community.

In August of 1961 in yet another instance of Hollywood blacklisting Atty. Gen. Robert Kennedy authorized a federal grand jury to be convened in the Southern District of New York to investigate numerous charges against MCA, including the charge of blacklisting. The request for authorization stated “MCA's power has created fear of retaliation, including the blacklist of talent and the boycotting of producers from access to main talent. The alleged existence of boycotts blacklist, predatory practices, and per se violations such as tie-ins may provide a basis for criminal suit, and thus make desirable and empanelling of a grand jury. After lengthy negotiations between attorneys for the Justice Department and MCA, a consent degree was issued and the case was considered closed.

Another form of control is the approval rights, in conjunction with the above-described varying levels of film finance, the distributor—dominated major studio/distributor organizations often require numerous film element approval rights to such items as the script, producer, director, lead actors/actresses, budget, final editing, running time, Motion Picture Association of America (MPAA) rating, lender and/or completion guarantor. Such approval rights significantly affect important creative aspects of the film project; thus, any time acquisition/development, production or distribution financing is provided by a studio/distributor entity, that financing is inextricably intertwined with a high level of creative control over the project.

The distributor typically advances all of the money to cover distribution expenses including the two largest items of distribution expenses, advertising and prints. Even in the rent a distributor scenario the distributor may still provide some of the so-called Print negative advertising (PNA) financing.

Creative control and accounting for films' proceeds are the two main problems that independent producers consistently encounter in their dealings with the major studio/distributors of Hollywood.

The distributor controls the flow of revenue on a film's backside, and without that control of revenue, neither film producers nor outside investors are likely to be able to fairly participate in the upside potential of their own films.

The distribution strategy is also a key control mechanism. The distributor is typically responsible for coming up with the overall plan employed in the film's release. Elements of the plan usually include the advertising and publicity strategy, timing of the release i.e. what is the optimum time during the year in which markets or cities and in what order, how to release i.e. single theater exclusive engagements, multiplex, wide release or saturation, along with the activities involved in preparing and handling the bidding process with exhibitors if used and negotiate the terms of exhibition when necessary.

The release sequence is an important part of distribution strategy. Motion pictures released sequence is partly a function of the marketplace and to some extent the prerogative of individual distributors; thus, release sequences change from time to time, as new delivery technology is introduced, and may vary with specific films. As a result of the different time periods during which movies are exhibited and/or viewed in various markets, the revenue stream generated by a given movie may typically continue for seven years and more.

Sample feature film release sequence domestic theatrical, pay-per-view, foreign theatrical, home video/DVD, pay television, foreign television, network TV, TV syndication. Another way to produce more income from a story originally on the screen is to retell it in a new medium.

Allegations have surfaced from time to time that the major studio/distributors have succeeded in improperly influencing union and guild executives with respect to agreement provisions that turn out to be less than favorable for the union or guild membership.

It is difficult to organize the creative community today because most of the people working in Hollywood are intimidated by the major studios and are so concerned about their own careers that few, if, any, are willing to take the necessary steps to bring about long-term, lasting reform in the film industry.

In an interview between Steven Speilberg, by David Helpern, he asked: “what attracted you to the Jaws project?” Spielberg: “I can tell the truth?” Helpern: “Go ahead, tell the truth.” Spielberg: “I could get into trouble if I told the truth.”

Another good example is the recent Hollywood trade guilds. The Writers Guild of America and the Screen Actors Guild (WGA and SAG) contract negotiations with the Motion Picture Association of America (MPAA) which represents the big six Hollywood studio/distributors who allowed a devastating strike (over 1 billion in loss of revenue) to cripple the writers guild, citizens and city of Los Angeles keeping people from working and causing great financial stress until the Writers Guild backed down and accepted the MPAA dictates regarding digital distribution, the Internet and the subsequent royalties that the MPAA would pay the members of Hollywood's largest guilds.

The Screen Actors Guild having lived thru the 2008 Writers Guild of America strike, are apprehensive for individual economic reasons to strike even though the current terms of their contract do not adequately address the digital rights issue that the guild members as content creators rely on for their livelihoods.

Politics, in its broadest sense, involves a great deal more than winning elections, appointing officials, or influencing legislation. In Harold Lasswell's classic definition, it involves “who gets what, when and how.” The “what” is both material goods, which create wealth, and favorable images, which create honor. In this sense of politics, motion pictures, which have the ability to establish honorific or pejorative images for whole classes of people, represent political power.

“The people in the White House think they have power. That's wrong. The people who make these (films) have power . . . they can get inside your head. They can completely take control of everything you see and do, change the way you feel, everything that happens to you, and that's power.”
Ben Stein, Her Only Sin

Hollywood does not want to escape its political orbit. Indeed, the new Hollywood major studio system is itself a product of three government interventions. The first came in 1948, when the Justice Department offered the studios a deal they could not refuse: either give up their control over major retail outlets (theaters) or face the consequences of a criminal antitrust investigation. The studios, one by one, signed the Justice Department's consent decree and, by doing so, relinquished their lucrative system of manufacturing filmed products for captive theatres. This left them little choice but to move into the riskier business of creating product that could be licensed and sold in competitive theatres.

Their profits, which were now problematic at best, depended not on box-office sales at theaters they controlled but on their long-term exploitation of intellectual properties in different markets.

The second government intervention came in 1970 by the early 1960's, the television audiences had grown to nearly ten times the size of the movie audience and, as Walt Disney and Lew Wasserman had demonstrated, production companies could make enormous profits by making game shows, series and other programs for the three networks and then syndicating them to local stations. By the time the major studios realized they needed access to this market, they faced a significant barrier: the networks. CBS, NBC and ABC effectively controlled access to the prime-time viewing audience, owned most of the major stations in the most important markets, decided which programs got aired, and owned subsidiaries that produced their programs. As long as the television networks could produce, air, and syndicate their own shows, the movie studios' opportunities were limited.

But unlike the movie business, television broadcasting is regulated by the government. The Federal Communications Commission (FCC), whose seven members are appointed by the President, grants six-year licenses for stations to broadcast over the public airwaves and issues the rules that they have to follow to get them renewed.

In 1970, after much lobbying in Washington by MCA's Lew Wasserman and other studio heads, the government intervened on the studios behalf and the FCC passed the fin-syn rule, which gave Hollywood studios such an insurmountable advantage over the networks in this business that they took over most of it.

The Financial Interest and Syndication Rules, widely known as fin-syn rules, were a set of rules imposed by the Federal Communications Committee of the U.S. in 1970. They sought to prevent vertical integration in the broadcast landscape by preventing the Big Three television networks from owning any of the programming that they aired in primetime.

Controversial from the very beginning, the fin-syn rule was relaxed slightly during the 1980s. Following the severe changes in the TV landscape, such as the rise of the Fox network and cable television the studios would again thru government action destroy its competition.

The third government intervention paved the way for the studios to merge with the television networks. The FCC weakened the fin-syn rule in the early 1990s and in 1995 abolished it altogether. This move allowed the studios and networks to become part of vertically integrated conglomerates that now control production, distribution, TV stations, TV networks, cable TV, satellite TV, and other means by which U.S. television content impacts not only the American public but a large part of the world as well.

The six major studio/distributors which already had underused sound stages, large staffs of technicians and substantial lines of credit at banks-further gained dominance in television by acquiring the libraries and production facilities of the leading independent television producers. As a result, the studios' cash cow became television, not movies. Columbia TriStar pictures, for example, came to depend on the syndication rights of series to generate billions of dollars in the 1990's.

Equally important, if less visible, are government decisions not to intervene in cartel-like arrangements. In the case of the DVD Consortium, for example, the U.S. Department of Justice not only permitted the arrangement between American studios and Japanese and European manufactures, it tacitly encouraged it. It will be recalled that in 1994 Time Warner and its Japanese partner, Toshiba, approached Sony and Philips, who jointly controlled the patents for the digital encoding of sound, and, concerned that Sony and Philips might use these patents to gain an advantage in the co-development arrangement, asked the Justice Department to issue guidelines concerning “the misuse and abuse of a dominant patent portfolio to restrict competition.” Relayed to them by Time Warner, the guidelines were taken by Sony and Phillips officials as a clear warning that the American government expected them to cooperate with Time Warner, and on Dec. 12, 1995, along with Time Warner, Toshiba and Matsushita (which then owned both Panasonic and Universal Pictures), Sony and Phillips pooled their patents into a single DVD Consortium. The patent agreement that emerged from this cartel effectively gave the Hollywood studio/distributors crucial control over where and when their movies were shown on DVD.

Because their principle profit centers were now located in areas that either were directly regulated by government, such as ownership of television stations, or benefited from governmental assistance, such as their control over the DVD, the major studio/distributors corporate parents had begun a partnership with the government.

For example, in the 1970's in the wake of the beneficial fin-syn rule, the Nixon administration convened a series of White House conferences with television producers and studio executives aimed at reshaping the image the public was getting of the drug issue in America. According to Egil Krogh, who then served as a Nixon strategist on domestic issues, Nixon and his attorney general, John Mitchell, believed that the administration's “war” on drugs would be helped if drug users were portrayed in movies and television not as mere “victims of addiction” but as “an integral part of the urban crime problem.” Instead of portraying drug abusers as merely self-destructive—as they appeared to be, for example, in Otto Preminger's Man with the Golden Arm (1955)—the major studio/distributors were asked by officials in the Nixon administration to portray them as menaces to the entire society. To this end, Krogh helped organize for the top producers and studio executives “dog and pony” shows in which law-enforcement officials demonstrated how drug dealers, acting as modern-day versions of evil vampires, infect their clients with an insatiable need to commit robberies and murders to get their ration of drugs and, in doing so, create a nationwide crime wave.

The production executives for these shows got the message. As one Warner Bros. vice president who attended the White House conference in 1971 explained: “these White House people made it clear that they wanted to see a lot more narco-villains, and that was okay with us.” Numerous memos were dutifully written by these executives to writers, advising them of ways in which they could use drug addicts as the villains in series. As a result, perpetrators of crime-were now commonly depicted as addicts. Any other group that the government does not agree with could be handled in the same way.

Two decades later, the government provided a more direct financial incentive to television stations to deliver antidrug messages. In 1997 Congress passed a law allowing networks to effectively get paid, through a complicated formula, for integrating in the plots of television series antidrug messages that were approved by the White House Office of National Drug Control Policy. To qualify, television executives often had to negotiate plot points in scripts with officials from this agency. As one Warner Bros. television executive explained, “the White House did view scripts. They did sign off on them.” Of course, even if it were not for such financial payments, television and studio executives have ample reason to cooperate because it is in their best interests. The studio/distributors deepening dependence on television requires that they take into account not only the desires of government officials but the influence that various interest groups have on Congress, the White House, and the FCC. After all, the local stations that show the programs, movies, and other material they produce are required to serve the “public interest” of their particular community. In theory, at least, stations could be denied licenses if the FCC found that their programming was a disservice to their community. In practice, television stations have rarely, if ever, failed to have their licenses renewed.

The Pentagon, if not a conventional interest group, has a clear interest in shaping the American public perception of its activities—if only to help it recruit soldiers. When it comes to movie companies using its facilities—planes, ships, bases, weapons and personnel—it lays down strict ground rules enforced by its Film Liaison office. Major studio/distributors can, of course, reject this free access and rent their own military, as, for example, Coppolla did at great cost for the making of Apocalypse Now, because the army did not like the way it portrayed the Viet Nam War, but if they accept it, as they usually do, they must also give this Pentagon office some control over the resulting images. “if you want to use the military's toys,” a consultant on such military films explained, “you've got to play by their rules.” This accommodation can be seen at work in the terms Disney agreed to in exchange for warships, planes and other military assistance for the film Pearl Harbor. Not only did the producers have to submit the script to the Pentagon, but they made changes proposed by the Pentagon's designated advisor. Such changes included replacing the depiction of American pilots as sassy, disdainful, and rebellious toward their superior officers with one that showed them as polite, respectful, and submissive to orders.

Recently, the CIA, following the Pentagon's lead, creating its own liaison office with Hollywood by supplying films—including: The Recruit, The Sum of All Fears, Enemy of the State, and Bad Company—with technical consultants, briefings, and even guild tours of its headquarters in Langley, Virginia, the CIA attempts to shape a more “realistic,” and presumably favorable, image of itself.

Similarly, foreign governments also often insist that movies filmed in their country-and that benefit from its locations, facilities, and, in some cases, tax subsidies depict their country, culture, and, most important, leadership in a favorable light. To ensure this cooperation, they often require filmmakers to submit scripts for approval. To be sure, some filmmakers are not willing to accept these conditions and find less politically sensitive countries to “double” for their subjects.

Even if there are no foreign censors, the studios or their corporate parents may impose their own ground rules on filmmakers to maintain good relations with the host government. Sony, the only corporate parent that does not—and is not allowed to own a television network in the United States, hews closely to the political ground rules of Japan (where it does have television interests as well as insurance, banking and other regulated businesses).

It is not uncommon for Hollywood films to rewrite history, which is one of the very good reasons why the power to make film should not rest in the hands of a few. Any film is capable of grave influence of some sort on the beliefs and behavior of the people who see them. Thus it is absolutely critical for this important communication medium to be fairly open to all, so that most, if not all points of views may be expressed.

It further illustrates the fact that all movies to one degree or another are propaganda. The propaganda of the people who control the making of movies or the views expressed in such movies generally reflect their personal perspectives. At least it is fair to say that studio executives are not likely to allow ideas they strongly disagree with or have interests that need to be protected to be portrayed in the movies they finance.

In the 1990's Hollywood found a valuable tie-in to their movies, licensing products to highly impressionable people under the age of twenty-five, their ability to reach a young audience is the basis on which merchandisers predict their lucrative tie-in deals, multiplex theaters provide the choice holiday play dates, video chains place massive advance orders for videos and DVDs, as the toy and game manufacturers license their characters. To maintain this influential control the major studio/distributors now concentrate 80 percent of their cable and broadcast-networks advertising on programs including music soundtracks to the films watched primarily by people under twenty-five.

The ultimate censorship is the movies that cannot get made. If the people who make the ultimate decisions about which movies get made are not culturally diverse, it is unlikely that those movies will be fully reflective of a cultural diverse society. It is very likely that hundreds of movies, expressing wildly varying points of view are not chosen to be produced because it is not in the interest of the people who control Hollywood, and, television that is legally obliged to be used for the entire public's good not just a narrowly defined few who can foist their views on the general public.

It is also very interesting to look at the remarkable range of considerations that must come into play for News Corporation, whose chairman, Rupert Murdoch, in 2002-2003 was lobbying the Chinese government to expand the reach of his Star TV's satellite service; the Italian government to facilitate his acquisition of the Telepiu, which pioneered pay television in Italy and Sky Italia, his satellite service to Italy: the U.S. government to formally approve his company's acquisition of DirecTV, the largest satellite company in America, as well as to loosen FCC restrictions on ownership of television stations; the Russian government to sell the satellite service of NTV, one of Russia's largest television networks; the German government to waive restrictions blocking him from buying part of bankrupt KirchMedia; and the British government to reduce support for the BBC's News 24, which directly competed with his Sky News.

To pursue their worldwide objectives, the corporate parents often are in need of allies abroad—a political consideration their studios must at least be aware of in producing movies or television programs and even news that might embarrass or offend officials whose goodwill is critical.

The six major studio/distributors need the acquiescence of those who can change the laws to accommodate their interests. Their corporate parents need the U.S. government's permission to complete their acquisition of all the television networks, cable networks, satellite broadcasters, pay-television channels, newspapers and stations in major cities to dominate the portals to their home-entertainment audience. They need laws mandating encryption devices on television sets to control consumer home use of their content without their authorization, or altering their regional restrictions on DVDs. They need censorship regime to guard against competitors fragmenting their market by offering more explicit material. They need exemption from Anti-Trust laws and other regulations so that they can reach agreement with one another on the standards, formats, and market protection for their content. A singular reality confronts the six major Hollywood studio/distributors; they need the support of governments in key countries to protect and expand their entertainment empires.

Even if the strategies for fulfilling these political requisites are confined to only the top echelons of the oligopoly, carrying them out affects decisions made at every level of the creative process and creates a status quo arrangement with those in power be they good or bad for the public. Remember television is licensed and regulated by the FCC for the public good which is more obviously for the good of the major Hollywood studio/distributors.

Now, the major Hollywood studio/distributors have their sites on the Holy Grail of communications, dominating the internet, which is the most democratic medium ever made. We shall see for how long.

HULU.com is an internet entertainment media distributor of News Corp.'s Fox and NBC/Universal content. A partnership between two public companies that should be competing with each other to maintain the public good are working together hand in hand, an interesting side note is that Rupert Murdoch, Chairman and CEO of News Corporation has a daughter Elisabeth who works for NBC/Universal. Aren't these relationships designed to dominate Internet entertainment media distribution too close or actually crossing the Antitrust laws of the United States regarding cartel like business practices?

The Sherman Anti-trust Act provides: “Every contract, combination in the form of trust or otherwise, or conspiracy, in restraint of trade or commerce among the several States, or with foreign nations, is declared to be illegal”. The Act also provides: “Every person who shall monopolize, or attempt to monopolize, or combine or conspire with any other person or persons, to monopolize any part of the trade or commerce among the several States, or with foreign nations, shall be deemed guilty of a felony”.

As stated above, the U.S. Government seems overly willing to grant Mr. Murdoch and his News Corporation who is pushing the envelope in media ownership, as well as the other five major media conglomerates special dispensation through legislation, in essence colluding with them to give them legal control of the media industry and the Internet to the detriment of the public good. This is not what is called for in the Sherman Anti-Trust law-it is a partnership with the six major media conglomerates thru their common business practices and acts as a government sponsored cartel.

Ultimately, the control of the Hollywood-based US film industry has been obtained illegitimately through the use of hundreds of business practices that can be collectively described as unfair, unethical, unconscionable, anticompetitive, predatory and illegal. It was gained and is maintained through the systematic and arbitrary exclusion from power of most Hollywood outsiders by the consistent practices utilized by the Hollywood insider group.

The lack of reliable statistical information is not available because the MPAA or any other research firm for Hollywood does not provide it to the public or government. The six major studio/distributors ownership of the majority of all production and distribution media in the U.S. is now permitted because of the reversal and blind eye given by the policies of the FCC and the U.S. Justice Department, the federal agencies charged with the responsibility of enforcing federal antitrust laws and what is good for the people of the United States.

Such laws are no longer vigorously enforced by the government in respect to the media industry—a change, at least partly brought about by the policies of the Reagan (a former studio star actor) administration in the 1980s and continued by the Clinton and Bush administrations. Each of these Presidents; two Republicans and one Democrat received substantial monetary contributions as candidates from the MPA A's political action committee, the highly paid studio executives of the various MPAA companies and their spouses, children and friends. Following the Reagan administration easing of regulatory restraints, the major studios/distributors have regained a high level of control over content production and the major distribution channels.

How does this control of the industry affect the shareholders of the major media conglomerates? A corporation's number one fiduciary responsibility is to its stockholders yet as described above a huge amount of money that should be given to shareholders as dividends is siphoned off by Hollywood executives and/or officers of the corporation during the production and distribution of media content.

Corporate law generally tries to provide some protection against the possibility that corporate officers or directors will take advantage of the so-called corporate opportunity to the detriment of the Corporation shareholders. The corporate opportunity involves a situation in which a person with a close relationship with the Corporation takes advantage of the special knowledge they acquire for personal gain. The term refers to a legal doctrine that directors or other investor with a fiduciary duty toward a corporation and its shareholders may not appropriate for their own benefit and advantage a business opportunity properly belonging to the Corporation. It would appear that several of the above cited conflict-of-interest situations, present clear examples of the violation of these well-established principles of law.

The board of directors of a corporation sets policy for the corporation and makes most of the important decisions for the entity these decisions are carried out on a day-to-day basis by corporate officers named by the board. As discussed above, even if the Hollywood insiders do not control a majority of the corporation's shares and, thus, are unable to maintain majority control over the board of directors, management (the corporations officers) is still able to communicate to the owners and board members in subtle or in overt ways. The message being sent is that if the traditional Hollywood management is not allowed to run the corporation as it sees fit, management will resign en masse. This will make it difficult for the company to find capable management to continue to run the company (which really means it will be difficult to find management that the rest of the Hollywood community will cooperate with, thus making it difficult for the company to survive).

This arrangement, in which autonomy for management remains intact as part of any restructuring, also defies efforts by stock holders to secure more return on their investments. This happens when the entertainment entity operates at an acceptable level of profitability but, for various reasons, a less than reasonable share of the profits seems to flow through to the equity share holders.

Shareholders are pretty much kept in the dark by studio management, saying with respect to motion picture studio accounting practices and tax dealings. The last people ever let in on the ‘game’ were the company's shareholders.

As stated above, the major studio/distributors in Hollywood, divisions of the major global media conglomerates (NBC Universal, Sony, Viacom/CBS, Disney/ABC, Time Warner, News Corp/Fox) supply over 90% of media content to the U.S.A thru monopolistic control of the industry by employing the Cartel (a formal organization of producers that agree to coordinate prices and production) like use of unfair, unethical, anti-competitive, predatory and illegal business practices, including provisions in the distribution deal between film distributors and producers. These unconscionable and some say illegal business practices are used to control a majority of the media industry to the detriment of the people of the United States because the majority of the ideas produced in Hollywood are self-serving corporate visions used to maintain control of this vital medium for the exchange of information. A free and open society depends on a myriad of views to remain a growing democracy.

A method and system for entertainment production financing using the Internet to sell “Participation Trust Units” alone or in groups that may be intermingled with other Participation Trust Units by an intermediary to the general public for a right to a payment that may or may not materialize based on the fact that in Hollywood most movies do not show any net profits is not a solution to the above mentioned problems.

Holders of Participation Trust Units do not have the right to audit any of the participating entertainment companies and none of the participating entertainment companies will have any accounting obligations to any holders of Participation Trust Units. Neither the financing entity nor any other holder of any contractual interest will have any copyright or ownership interest, or other property right, in any Output film underlying the contractual interest. Ergo, there is no ownership or equity in a media production company for the investor using this system. This system selling Participation Trust Units to the general public is geared to raising capital for slates of media productions involving the major studio/distributors. This above system does nothing to solve the problems affecting the independent entertainment media industry that has no access to the major studio/distributors or significant debt financing facilities such as banks. In essence, this system is an extremely complex financial transaction that does not give any equity share of any media production company to the public investor and actually reinforces the Hollywood studio system which is the problem.

The prior art relating to a stock exchange type Hollywood trading system such as the Hollywood Stock Exchange, are online-games, based on the Hollywood studio system, that trade simulated stock in existing media and talent. This website has no bearing on real world finance for the production of entertainment media.

Using a story and an Internet website to raise capital can be and has been done previously. However, selling securities of a company thru any medium is tightly regulated by the SEC (Security and Exchange Commission) and State Blue Sky Laws (A blue sky law is a state law in the United States that regulates the offering and sale of securities to protect the public from fraud.) It is very difficult to do a Direct Public Offering (DPO) on the Internet because of the strict enforcement of U.S. Federal and State Laws and SEC regulations regarding the selling of stock to the public. Many companies have tried DPO's but found the impracticality of this method of raising capital because they cannot meet the government's high standards for selling stock.

Pre-selling advertising to raise funds for media productions is not an equity offering. Offering a promise of a future entitlement of some kind, namely a DVD of the movie after the funds have been raised and the production completed, is also regulated by U.S. Federal and State laws and SEC rules even though it is not a cash dividend or equity stock that can be traded on an exchange like the New York Stock Exchange (NYSE) or the NASDAQ (National Association of Securities Dealers Automated Quotations), as is the normal practice with SEC regulated stocks.

Asking for a contribution to produce entertainment content via the Internet with no financial remuneration to the contributor is a worthy act by an individual that would like to support the arts but is not a reasonable way to generate the extremely large amounts of capital necessary to professionally produce a movie or other professionally produced entertainment media products.

The prior art does not provide a solution to the problems discussed above and/or provide a robust or affordable way to overcome the problems of making entertainment media and the distribution mediums more democratic. These methods will not change the way the Hollywood studio system operates.

### SUMMARY

The combination of a Social Network Service (SNS), Alternative Trading System (ATS) and Electronic Communication Networks (ECN) are a method and/or system that enables independent producers of entertainment media to readily find the capital that they require to create their art and distribute it through established and future distribution models. By so doing a major barrier to entry into the media industry has been removed. By using the combined SNS, ATS and ECN, independent producers of entertainment media can have their voices heard by society enabling a more diverse and democratic America to emerge.

The problem(s) of Independent Producers of Entertainment Media gaining access to liquidity in the capital markets for use in creating and distributing their media content as well as Individual and Institutional Investors who wish to be involved in and benefit from Initial Public Offerings and Secondary Trading of Independent Entertainment Media Companies Equity Stock is (are) solved by combining a Social Network Service with a Alternative Trading System and Electronic Communications Network.

A Social Network Service focuses on building online communities of people who share interests and/or activities, or who are interested in exploring the interests and activities of others. Most Social Network Services are web based and provide a variety of ways for users to interact, such as e-mail and instant messaging services.

Social networking has created new ways to communicate and share information. Social networking websites are being used regularly by millions of people, and it now seems that social networking will be an enduring part of everyday life. The main types of Social Networking Services are those which contain directories of some categories (such as former classmates), means to connect with friends (usually with self-description pages), and recommender systems linked to trust. Popular methods now combine many of these, with MySpace and Facebook being the most widely used in North America.

Social networks connect people at low cost; this can be beneficial for entrepreneur and small business looking to expand their contact base. These networks often act as a customer relationship management tool for companies selling products and services. Companies can also use social networks for advertising in the form of banners and text ads. Since businesses operate globally, social networks can make it easier to keep in touch with contacts around the world.

One example of social networking being used for business purposes is LinkedIn.com, which aims to interconnect professionals. LinkedIn has over 36 million users in over 200 countries.

Professional networking sites function as online meeting places for business and industry professionals. Other sites are bringing this model for niche business professional networking.

Virtual communities for business allow individuals to be accessible. People establish their real identity in a verifiable place. These individuals then interact with each other or within groups that share common business interests and goals. They can also post their own user generated content in the form of blogs, pictures, slide shows and videos. Like a social network, the consumer essentially becomes the publisher.

A professional network is used for the business to business marketplace. These networks improve the ability for people to advance professionally, by finding, connecting and networking with others. Business professionals can share experiences with others who have a need to learn from similar experiences.

The traditional way to interact is face-to-face. Interactive technology makes it possible for people to network with their peers from anywhere, at anytime in an online environment. Professional network services attract, aggregate and assemble large business-focused audiences by creating informative and interactive meeting places.

Alternative Trading Systems (ATS) are SEC-approved non-exchange trading venues. They play an important role in public markets for allowing alternative means of accessing liquidity.

Rule 300(a) of the SEC's regulation ATS provides the following legal definition of an “alternative trading system”:

Any organization, association, person, group or persons, or system:

That constitutes, maintains, or provides a market place or facilities for bringing together purchasers and sellers of securities or for otherwise performing with respect to securities the functions commonly performed by a stock exchange within the meaning of Rule 3b-16 of this chapter.

Electronic Communication Networks or ECN's as defined in rule 600(b) (23) of regulation NMS, are electronic trading systems that automatically match buy and sell orders at specified prices. ECN's register with the SEC as broker-dealers and are subject to regulation ATS.

By creating and combining a Social Network Service, Alternative Trading System, and Electronic Communication Networks that has listing requirements, SEC regulations and fees that are tailored to the needs of independent producers of entertainment media vs. the extremely expensive and regulatory prohibitive stock exchanges like the NYSE (New York Stock Exchange) or the NASDAQ (National Association of Securities Dealers Automated Quotations), gives independent producers and investors a capital market not known to them before.

By combining a Social Network Service, Alternative Trading System and Electronic Communication Networks where producers can easily find readily available capital will enable a multitude of producers of entertainment media to take advantage of the application and by so doing will create a new independent Hollywood system that can rival and even surpass the old Hollywood studio system. In Hollywood, the people who have the capital make the rules as far as the way they work so that a producer using the application can create their art the way they envision it.

In order to break the strangle hold Hollywood's major studio/distributors have over media content, distribution, independent producers and talent, there must be a sufficient amount of stock trading volume to create a vibrant market, a Social Network Service, combined with an Alternative Trading Network and Electronic Communication Networks will create the venue for such volume transactions to occur.

Combination of a Social Network Service with an Alternative Trading System and Electronic Communication Networks will also enable investors who have received less compensation than they could have received from the major media conglomerates stock, which is being manipulated thru the insider production and distribution deal's of Hollywood's major studio/distributors, to get their fair share of the rewards of investing in entertainment media and mediums.

Using the application more and perhaps better, media content can be created by independent producers and distributed thru the Internet (Netflix, iTunes, Amazon, YouTube, Wal-Mart and other online and physical outlets) as well as traditional venues. By enabling independent, professionally produced, content to be created, a well rounded view of our world can be had that will benefit every person in our society because it adds to the public good that should be protected in our democracy.

### BRIEF DESCRIPTION OF THE DRAWING

FIG. 1 is a flowchart that describes one of many embodiments of the method and system of the application.

### DETAILED DESCRIPTION

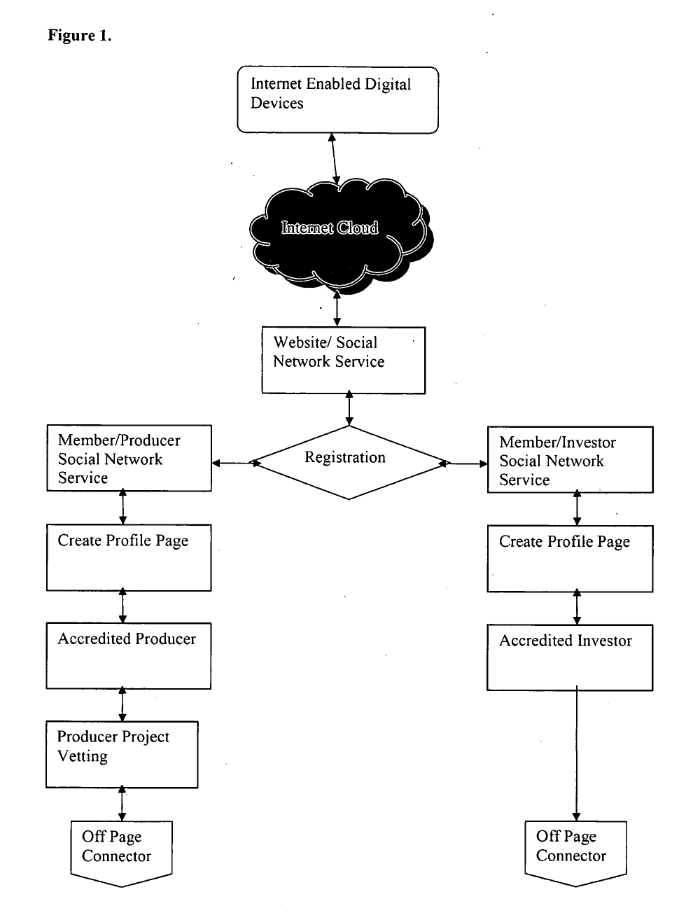

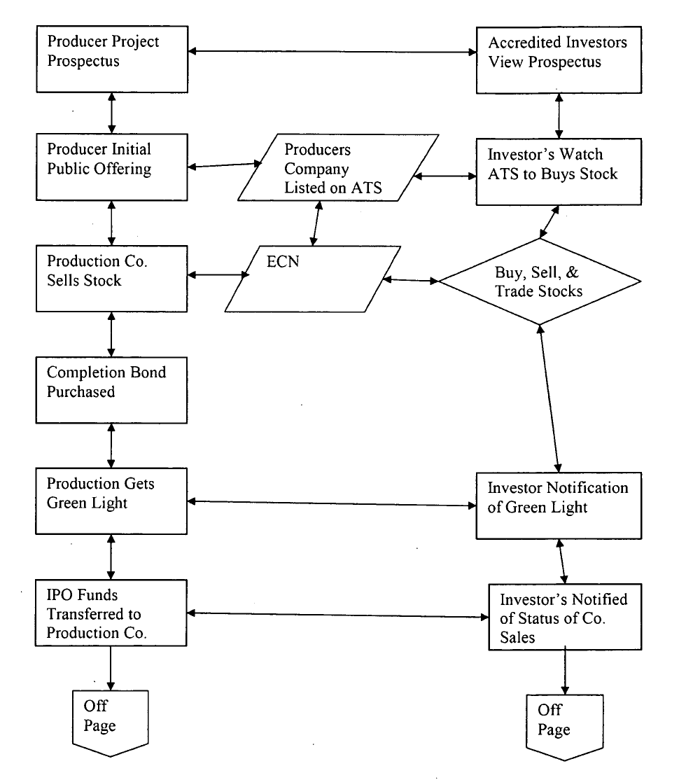

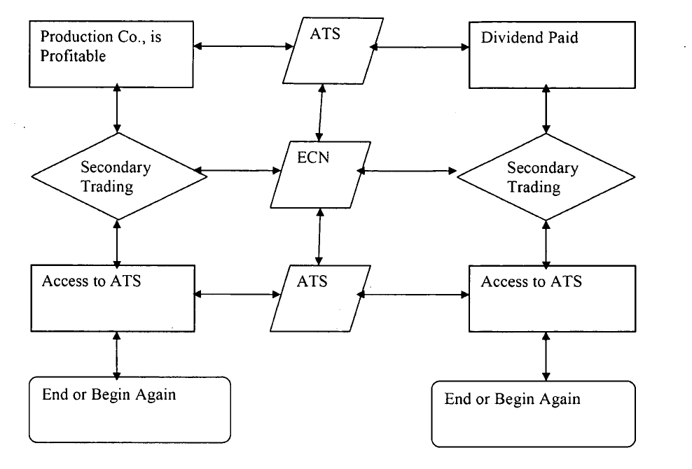

### FIG. 1—First Embodiment

One embodiment of the combination of a Social Network Service, Alternative Trading System and Electronic Communication Networks is illustrated in the flowchart of FIG. 1, where a person will begin using the application by having access to a Internet enabled digital device i.e. a mobile phone or a computer, etc., which is used to connect with the Social Network Service, Alternative Trading System and Electronic Communication Networks through the Internet.

The Internet is a global network of interconnected computers, enabling users to share information along multiple channels. Typically, a computer that connects to the Internet can access information from a vast array of available servers and other computers by moving information from them to the computer's local memory. The same connection allows that computer to send information to servers on the network; that information is in turn accessed and potentially modified by a variety of other interconnected computers. A majority of widely accessible information on the Internet consists of inter-linked hypertext documents and other resources of the World Wide Web (WWW). Computer users typically manage sent-and-received information with web browsers. Other software for users' interface with computer networks includes specialized programs for online banking, electronic mail, online chat, file transfer and file sharing.

The movement of information in the Internet is achieved via a system of interconnected computer networks that share data by packet switching using the standardized Internet Protocol Suite (TCP/IP). It is a “network of networks” that consists of millions of private and public, academic, business, and government networks of local to global scope that are linked by copper wires, fiber-optic cables, wireless connections, and other technologies.

Common methods of access include dial-up, landline broadband (over coaxial cable, fiber optic or copper wires), Wi-Fi, satellite and 3G technology cell phones. Apart from Wi-Fi, there have been experiments with proprietary mobile wireless networks like Ricochet, various high-speed data services over cellular phone networks, and fixed wireless services.

High-end mobile phones such as smart phones generally come with Internet access through the phone network. Web browsers such as Opera are available on these advanced handsets, which can also run a wide variety of other Internet software. More mobile phones have Internet access than PCs, though this is not as widely used. An Internet access provider and protocol matrix differentiates the methods used to get online.

The Internet allows computer users to connect to other computers and information stores easily wherever they may be across the world. They may do this with or without the use of security, authentication and encryption technologies, depending on the requirements.

This is encouraging new ways of working from a distance, collaboration and information sharing in many industries. An accountant sitting at home can audit the books of a company based in another country, on a server situated in a third country that is remotely maintained by IT specialists in a fourth. These accounts could have been created by home-working bookkeepers, in other remote locations, based on information e-mailed to them from offices all over the world. Some of these things were possible before the widespread use of the Internet, but the cost of private leased lines would have made many of them unfeasible in practice.

An office worker away from his desk, perhaps on the other side of the world on a business trip or a holiday, can open a remote desktop session into his normal office PC using a secure Virtual Private Network (VPN) connection via the Internet. This gives the person complete access to all of his or her normal files and data, including e-mail and other applications, while away from the office.

The low cost and nearly instantaneous sharing of ideas, knowledge, and skills has made collaborative work dramatically easier. Not only can a group cheaply communicate and share ideas, but the wide reach of the Internet allows such groups to easily form in the first place. An example of this is the free software movement, which has produced Linux, Mozilla Firefox, OpenOffice.org etc.

Internet “chat”, whether in the form of IRC chat rooms or channels, or via instant messaging systems, allow colleagues to stay in touch in a very convenient way when working at their computers during the day. Messages can be exchanged even more quickly and conveniently than via e-mail. Extensions to these systems may allow files to be exchanged, “whiteboard” drawings to be shared or voice and video contact between team members.

Version control systems allow collaborating teams to work on shared sets of documents without either accidentally overwriting each other's work or having members wait until they get “sent” documents to be able to make their contributions.

Business and project teams can share calendars as well as documents and other information. Such collaboration occurs in a wide variety of areas including scientific research, software development, conference planning, political activism and creative writing.

A computer file can be e-mailed to customers, colleagues and friends as an attachment. It can be uploaded to a website or FTP server for easy download by others. It can be put into a “shared location” or onto a file server for instant use by colleagues. The load of bulk downloads to many users can be eased by the use of “mirror” servers or peer-to-peer networks.

In any of these cases, access to the file may be controlled by user authentication, the transit of the file over the Internet may be obscured by encryption, and money may change hands for access to the file. The price can be paid by the remote charging of funds from, for example, a credit card whose details are also passed-hopefully fully encrypted-across the Internet. The origin and authenticity of the file received may be checked by digital signatures or by MD5 or other message digests.

These simple features of the Internet, over a worldwide basis, are changing the production, sale, and distribution of anything that can be reduced to a computer file for transmission. This includes all manner of print publications, software products, news, music, film, video, photography, graphics and the other arts. This in turn has caused seismic shifts in each of the existing industries that previously controlled the production and distribution of these products.

Many existing radio and television broadcasters provide Internet “feeds” of their live audio and video streams (for example, the BBC). They may also allow time-shift viewing or listening such as Preview, Classic Clips and Listen Again features. These providers have been joined by a range of pure Internet “broadcasters” who never had on-air licenses. This means that an Internet-connected device, such as a computer or something more specific, can be used to access on-line media in much the same way as was previously possible only with a television or radio receiver. The range of material is much wider and can range from viewing a newspaper to highly specialized, technical webcasts. Podcasting is a variation on this theme, where—usually audio—material is downloaded and played back on a computer or shifted to a portable media player to be listened to on the move. These techniques using simple equipment allow anybody, with little censorship or licensing control, to broadcast audio-visual material on a worldwide basis.

Webcams can be seen as an even lower-budget extension of this phenomenon. While some webcams can give full-frame-rate video, the picture is usually either small or updates slowly. Internet users can watch animals around an African waterhole, ships in the Panama Canal, traffic at a local roundabout or monitor their own premises, live and in real time. Video chat rooms and video conferencing are also popular with many uses being found for personal webcams, with and without two-way sound.

YouTube was founded on 15 Feb. 2005 and is now the leading website for free streaming video with a vast number of users. It uses a flash-based web player to stream and show the video files. Users are able to watch videos without signing up; however, if they do sign up, they are able to upload an unlimited amount of videos and build their own personal profile. YouTube claims that its users watch hundreds of millions, and upload hundreds of thousands, of videos daily.

The Internet has also become a large market for companies; some of the biggest companies today have grown by taking advantage of the efficient nature of low-cost advertising and commerce through the Internet, also known as e-commerce. It is the fastest way to spread information to a vast number of people simultaneously. The Internet has also subsequently revolutionized shopping—for example; a person can order a CD online and receive it in the mail within a couple of days, or download it directly in some cases. The Internet has also greatly facilitated personalized marketing which allows a company to market a product to a specific person or a specific group of people more so than any other advertising medium.

Examples of personalized marketing include online communities such as MySpace, Friendster, Orkut, Facebook and others which thousands of Internet users join to advertise themselves and make friends online. Many of these users are young teens and adolescents ranging from 13 to 25 years old. In turn, when they advertise themselves they advertise interests and hobbies, which online marketing companies can use as information as to what those users will purchase online, and advertise their own companies' products to those users.

The Internet has made possible entirely new forms of social interaction, activities and organizing, thanks to its basic features such as widespread usability and access.

Social networking websites such as Facebook and MySpace have created a new form of socialization and interaction. Users of these sites are able to add a wide variety of items to their personal pages, to indicate common interests, and to connect with others. It is also possible to find a large circle of existing acquaintances, especially if a site allows users to utilize their real names, and to allow communication among large existing groups of people.

The user of the application will go through the Internet to reach the Social Network Service, Alternative Trading System and Electronic Communication Networks website. From the home page of the website the user will be able to access the registration page. Once the user is registered as a member they can access the SNS, ATS and ECN's website contents.

A website (or “web site”) is a collection of related web pages, images, videos or other digital assets that are hosted on one web server, usually accessible via the Internet.

A web page is a document, typically written in (X) HTML, that is almost always accessible via HTTP, a protocol that transfers information from the web server to display in the user's web browser.

All publicly accessible websites are seen collectively as constituting the “World Wide Web”.

The pages of a website can usually be accessed from a common root URL called the homepage, and usually reside on the same physical server. The URLs of the pages organize them into a hierarchy, although the hyperlinks between them control how the reader perceives the overall structure and how the traffic flows between the different parts of the site.

Some websites require a subscription to access some or all of their content. Examples of subscription sites include many business sites, parts of many news sites, academic journal sites, gaming sites, message boards, Web-based e-mail, services, social networking websites, and sites providing real-time stock market data. Because they require authentication to view the content they are technically an Intranet site.

Organized by function a website may be
a personal website
a commercial website
a government website
a non-profit organization website

It could be the work of an individual, a business or other organization, and is typically dedicated to some particular topic or purpose. Any website can contain a hyperlink to any other website, so the distinction between individual sites, as perceived by the user, may sometimes be blurred.

Websites are written in, or dynamically converted to, HTML (Hyper Text Markup Language) and are accessed using a software interface classified as a user agent. Web pages can be viewed or otherwise accessed from a range of computer-based and Internet-enabled devices of various sizes, including desktop computers, laptops, PDAs and cell phones.

A website is hosted on a computer system known as a web server, also called an HTTP server, and these terms can also refer to the software that runs on these systems and that retrieves and delivers the web pages in response to requests from the website users. Apache is the most commonly used web server software (according to Netcraft statistics) and Microsoft's Internet Information Server (IIS) is also commonly used.

A static website is one that has web pages stored on the server in the same form as the user will view them. It is primarily coded in HTML (Hyper-text Markup Language).

A static website is also called a classic website, a five-page website or a brochure website because it simply presents pre-defined information to the user. It may include information about a company and its products and services via text, photos, Flash animation, audio/video and interactive menus and navigation. This type of website usually displays the same information to all visitors, thus the information is static. Similar to handing out a printed brochure to customers or clients, a static website will generally provide consistent, standard information for an extended period of time. Although the website owner may make updates periodically, it is a manual process to edit the text, photos and other content and may require basic website design skills and software.

In summary, visitors are not able to control what information they receive via a static website, and must instead settle for whatever content the website owner has decided to offer at that time.

They are edited using four broad categories of software:
Text editors, such as Notepad or Textedit, where the HTML is manipulated directly within the editor program
WYSIWYG offline editors, such as Microsoft FrontPage and Adobe Dreamweaver (previously Macromedia Dreamweaver), where the site is edited using a GUT interface and the underlying HTML is generated automatically by the editor software
WYSIWYG Online editors, where the any media rich online presentation like websites, widgets, intro, blogs etc. are created on a flash based platform
Template-based editors, such as Rapidweaver and iWeb, which allow users to quickly create and upload websites to a web server without having to know anything about HTML, as they just pick a suitable template from a palette and add pictures and text to it in a DTP-like fashion without ever having to see any HTML code.

A dynamic website is one that does not have web pages stored on the server in the same form as the user will view them. Instead, the web page content changes automatically and/or frequently based on certain criteria. It generally collates information on the hop each time a page is requested.

A website can be dynamic in one of two ways. The first is that the web page code is constructed dynamically, piece by piece. The second is that the web page content displayed varies based on certain criteria. The criteria may be pre-defined rules or may be based on variable user input.

The main purpose behind a dynamic website is that it is much simpler to maintain a few web pages plus a database than it is to build and update hundreds or thousands of individual web pages and links. In one way, a data-driven website is similar to a static site because the information that is presented on the site is still limited to what the website owner has allowed to be stored in the database (data entered by the owner and/or input by users and approved by the owner). The advantage is that there is usually a lot more information stored in a database and made available to users.

A dynamic website also describes its construction or how it is built, and more specifically refers to the code used to create a single web page. A dynamic web page is generated on the fly by piecing together certain blocks of code, procedures or routines. A dynamically-generated web page would call various bits of information from a database and put them together in a pre-defined format to present the reader with a coherent page. It interacts with users in a variety of ways including by reading cookies recognizing users' previous history, session variables, server side variables etc., or by using direct interaction (form elements, mouseovers, etc.). A site can display the current state of a dialogue between users, monitor a changing situation, or provide information in some way personalized to the requirements of the individual user.

Some countries, for example the U.K. and the U.S., have introduced legislation regarding web accessibility.

There are a wide range of software systems, such as Java Server Pages (JSP), the PHP and Perl programming languages, Active Server Pages (ASP), YUMA and Cold Fusion (CFM) that are available to generate dynamic web systems and dynamic sites. Sites may also include content that is retrieved from one or more databases or by using XML-based technologies such as RSS.

Static content may also be dynamically generated either periodically, or if certain conditions for regeneration occur (cached) in order to avoid the performance loss of initiating the dynamic engine on a per-user or per-connection basis.

Plug ins are available to expand the features and abilities of web browsers, which use them to show active content, such as Flash, Shockwave or applets written in Java. Dynamic HTML also provides for user interactivity and mealtime element updating within web pages (i.e., pages don't have to be loaded or reloaded to effect any changes), mainly using the DOM and Javascript, support which is built-in to most modern web browsers.

Turning a website into an income source is a common practice for web developers and website owners. There are several methods for creating a website business which fall into two broad categories, as defined below.

Some websites derive revenue by selling advertising space on the site (see contextual ads).

Some websites derive revenue by offering products or services for sale. In the case of e-commerce websites, the products or services may be purchased at the website itself, by entering credit card or other payment information into a payment form on the site. While most business websites serve as a shop window for existing brick and mortar businesses, it is increasingly the case that some websites are businesses in their own right; that is, the products they offer are only available for purchase on the web.

Websites occasionally derive income from a combination of these two practices. For example, a website such as an online auctions website may charge the users of its auction service to list an auction, but also display third-party advertisements on the site, from which it derives further income.

There are many varieties of websites, each specializing in a particular type of content or use, and they may be arbitrarily classified in any number of ways. A few such classifications might include:
Affiliate: enabled portal that renders not only its custom CMS but also syndicated content from other content providers for an agreed fee. There are usually three relationship tiers. Affiliate Agencies (e.g., Commission Junction), Advertisers (e.g., Ebay) and consumer (e.g., Yahoo).
Archive site: used to preserve valuable electronic content threatened with extinction. Two examples are: Internet Archive, which since 1996 has preserved billions of old (and new) web pages; and Google Groups, which in early 2005 was archiving over 845,000,000 messages posted to Usenet news/discussion groups.
Blog (or web log) site: sites generally used to post online diaries which may include discussion forums (e.g., blogger, Xanga).
Content site: sites whose business is the creation and distribution of original content (e.g., Slate, About.com).
   Corporate website: used to provide background information about a business, organization, or service. (e.g., Ens)
   Commerce site (or eCommerce site): for purchasing goods, such as Amazon.com, CSN Stores, and Overstock.com.
   Community site: a site where persons with similar interests communicate with each other, usually by chat or message boards, such as Myspace or Facebook.
   City Site: A site that shows information about a certain city or town and events that takes place in that town. Usually created by the city council or other “movers and shakers”.
   The same as those of geographic entities, such as cities and countries. For example, Richmond.com is the geo domain for Richmond, Va.
   Gripe site: a site devoted to the critique of a person, place, corporation, government, or institution.
   Humor site: satirizes, parodies or otherwise exists solely to amuse.
   Information site: contains content that is intended to inform visitors, but not necessarily for commercial purposes, such as: RateMyProfessor.com, Free Internet Lexicon and Encyclopedia. Most government, educational and non-profit institutions have an informational site.
   Java applet site: contains software to run over the Web as a Web application.
   Mirror site: A complete reproduction of a website.
   News site: similar to an information site, but dedicated to dispensing news and commentary.
   Personal homepage: run by an individual or a small group (such as a family) that contains information or any content that the individual wishes to include. These are usually uploaded using a web hosting service such as Geocities.
   Phish site: a website created to fraudulently acquire sensitive information, such as passwords and credit card details, by masquerading as a trustworthy person or business (such as Social Security Administration, PayPal) in an electronic communication (see Phishing).
   Political site: A site on which people may voice political views.
   Porn site—a site that shows sexually explicit content for enjoyment and relaxation, most likely in the form of an internet gallery, dating site, blog, or video sharing.
   Rating site: A site on which people can praise or disparage what is featured.
   Review site: A site on which people can post reviews for products or services.
   School site: a site on which teachers, students, or administrators can post information about current events at or involving their school. U.S. websites generally uses k12 in the URL such as kearney.k12.mo.us.
   Video sharing: A site that enables user to upload videos, such as YouTube and Google Video.
   Search engine site: a site that provides general information and is intended as a gateway or lookup for other sites. A pure example is Google, and the most widely known extended type is Yahoo!.
   Shock site: includes images or other material that is intended to be offensive to most viewers (e.g. rotten.com).
Warez: a site designed to host and let users download copyrighted materials illegally.
   Web portal: a site that provides a starting point or a gateway to other resources on the Internet or an intranet.
   Wiki site: a site which users collaboratively edit (such as Wikepedia and Wikihow).

Some websites may be included in one or more of these categories. For example, a business website may promote the business's products, but may also host informative documents, such as white papers. There are also numerous sub-categories to the ones listed above. For example, a porn site is a specific type of eCommerce site or business site (that is, it is trying to sell memberships for access to its site). A fan site may be a dedication from the owner to a particular celebrity.

Websites are constrained by architectural limits (e.g., the computing power dedicated to the website). Very large websites, such as Yahoo!, Microsoft, and Google employ many servers and load balancing equipment such as Cisco Content Services Switches to distribute visitor loads over multiple computers at multiple locations.

In February 2009, Netcraft, an Internet monitoring company that has tracked Web growth since 1995, reported that there were 215,675,903 websites with domain names and content on them in 2009, compared to just 18,000 websites in August 1995.

If the new member of the Social Network Service, Alternative Trading System and Electronic Communication Networks, wishes they can create a user profile (userprofile, or simply profile when used in-context) is a collection of personal data associated to a specific user. A profile refers therefore to the explicit digital representation of a person's identity. A user profile can also be considered as the computer representation of a user model.

Typically online forums have user profiles where the user can write a short resume about himself and add a photo and where statistical information about the user is displayed.

Profiles are also elaborated in online social networking services such as Facebook or LinkedIn in which people have the possibility to describe their identity. The information available from user profiles is also used to personalize the interaction

A profile can be used to store the description of the characteristics of person. This information can be exploited by systems taking into account the persons' characteristics and preferences. For instance profiles can be used by adaptive hypermedia systems that personalize the human computer interaction.

The information gathered in the members registration statement will be used to ascertain if the member is an accredited or non-accredited investor. Accredited Investor is a term defined by various securities laws that delineates investors permitted to invest in certain types of higher risk investments, limited partnerships, hedge funds, and angel investors' networks. The term generally includes wealthy individuals and organizations such as a corporation, endowment, or retirement plans.

In the United States, for an individual to be considered an accredited investor, they must have a net worth of at least one million US dollars or have made at least $200,000 each year for the last two years ($300,000 with his or her spouse if married) and have the expectation to make the same amount this year.” This rule came into effect in 1933 by way of the Securities Act of 1933.

When the Member/Producer decides that they want to use the Social Network Service, Alternative Trading System and the Electronic Communication Networks to raise capital for their media production they will be vetted by a team of professionals skilled in the art of financial services and media management.

Vetting is a process of examination and evaluation, generally referring to performing a background check on someone before offering him or her employment. In addition, in intelligence gathering, assets are vetted to determine their usefuIness.

If the Member/Producer has been vetted successfully they will be able to offer equity stock in their production company to the Member/Investors of the Social Network Service, Alternative Trading System and Electronic Communication Networks. The member's production company will post a Prospectus on their profile page that will be accessible to Member/Investors if they meet the standards regarding US laws and SEC regulations.

A Prospectus is a legal document that institutions and businesses use to describe the securities they are offering for participants and buyers. A prospectus commonly provides investors with material information about mutual funds, stocks, bonds and other investments, such as a description of the company's business, financial statements, biographies of officers and directors, detailed information about their compensation, any litigation that is taking place, a list of material properties and any other material information. In the context of an individual securities offering, such as an initial public offering, a prospectus is distributed by underwriters or brokerages to potential investors.

In a securities offering in the United States, a prospectus is required to be filed with the Securities and Exchange Commission (SEC) as part of a registration statement. The issuer may not use the prospectus to finalize sales until the registration statement has been declared effective by the SEC, meaning it appears to comply on its face with the various rules governing disclosure.

If a company has been filing Form 10-K with the SEC for a certain period of time, has a market capitalization above a certain threshold and takes certain procedural steps, it is permitted to offer securities using a simplified prospectus that incorporates information by reference to its SEC filings. In certain situations, such as when the offering is not required to be registered with the SEC, a prospectus is instead referred to as an “offering memorandum” or “offering circular.” Prospectuses are generally prepared with the assistance of the underwriter acting as issue manager (also called a book running manager). They also explain the Assets and Liabilities.

After the SEC approved prospectus has been offered to Member/Investors for their perusal an Initial Public Offering can occur that meets the needs of the Member/Producer wanting to raise financial capital for their media project.

Initial Public Offerings (IPO) are usually done by smaller, younger companies seeking capital to expand, but can also be done by large privately-owned companies looking to become publicly traded.

An IPO can be a risky investment. For the individual investor, it is tough to predict what the stock or shares will do on its initial day of trading and in the near future since there is often little historical data with which to analyze the company. Also, most IPOs are of companies going through a transitory growth period, and they are therefore subject to additional uncertainty regarding their future value.

When a company lists its shares on a public exchange, it will almost invariably look to issue additional new shares in order to raise extra capital at the same time. The money paid by investors for the newly-issued shares goes directly to the company (in contrast to a later trade of shares on the exchange, where the money passes between investors). An IPO, therefore, allows a company to tap a wide pool of stock market investors to provide it with large volumes of capital for future growth. The company is never required to repay the capital, but instead the new shareholders have a right to future profits distributed by the company and the right to a capital distribution in case of a dissolution.

The existing shareholders will see their shareholdings diluted as a proportion of the company's shares. However, they hope that the capital investment will make their shareholdings more valuable in absolute terms.

In addition, once a company is listed, it will be able to issue further shares via a rights issue, thereby again providing itself with capital for expansion without incurring any debt. This regular ability to raise large amounts of capital from the general market, rather than having to seek and negotiate with individual investors, is a key incentive for many companies seeking to list.

IPOs generally involve one or more investment banks as “underwriters.” The company offering its shares, called the “issuer,” enters a contract with a lead underwriter to sell its shares to the public. The underwriter then approaches investors with offers to sell these shares.

The sale (that is, the allocation and pricing) of shares in an IPO may take several forms. Common methods include:
Best efforts contract
Firm commitment contract
All-or-none contract
Bought deal
Dutch auction
Self distribution of stock

A large IPO is usually underwritten by a “syndicate” of investment banks led by one or more major investment banks (lead underwriter). Upon selling the shares, the underwriters keep a commission based on a percentage of the value of the shares sold. Usually, the lead underwriters, i.e. the underwriters selling the largest proportions of the IPO, take the highest commissions—up to 8% in some cases.

Multinational IPOs may have as many as three syndicates to deal with differing legal requirements in both the issuer's domestic market and other regions. For example, an issuer based in the E.U. may be represented by the main selling syndicate in its domestic market, Europe, in addition to separate syndicates or selling groups for US/Canada and for Asia. Usually, the lead underwriter in the main selling group is also the lead bank in the other selling groups.

Usually, the offering will include the issuance of new shares, intended to raise new capital, as well the secondary sale of existing shares. However, certain regulatory restrictions and restrictions imposed by the lead underwriter are often placed on the sale of existing shares.

Public offerings are primarily sold to institutional investors, but some shares are also allocated to the underwriters' retail investors. A broker selling shares of a public offering to his clients is paid through a sales credit instead of a commission. The client pays no commission to purchase the shares of a public offering; the purchase price simply includes the built-in sales credit.

The issuer usually allows the underwriters an option to increase the size of the offering by up to 15% under certain circumstance known as the green shoe or over allotment option.

The first sale of stock by a private company to the public, IPOs are often issued by smaller, younger companies seeking the capital to expand, but can also be done by large privately owned companies looking to become publicly traded.

In an IPO, the issuer obtains the assistance of an underwriting firm, which helps it determine what type of security to issue (common or preferred), the best offering price and the time to bring it to market

Initial founders could often become overnight millionaires, and due to generous stock options, employees could make a great deal of money as well. The majority of IPOs could be found on the NASDAQ (National Association of Dealers Automated Quotations) stock exchange, which lists companies related to computer and information technology.

A venture capitalist named Bill Hambrecht has attempted to devise a method that can reduce the inefficient process. He devised a way to issue shares through a Dutch auction as an attempt to minimize the extreme under-pricing that underwriters were nurturing. Underwriters, however, have not taken to this strategy very well. Though not the first company to use Dutch auction, Google is one established company that went public through the use of auction. Google's share price rose 17% in its first day of trading despite the auction method. Perception of IPOs can be controversial. For those who view a successful IPO to be one that raises as much money as possible, the IPO was a total failure. For those who view a successful IPO from the kind of investors that eventually gained from the under-pricing, the IPO was a complete success. It's important to note that different sets of investors bid in auctions versus the open market-more institutions bid, fewer private individuals bid. Google may be a special case, however, as many individual investors bought the stock based on long-term valuation shortly after it launched its IPO, driving it beyond institutional valuation.

A company that is planning an IPO appoints lead managers to help it decide on an appropriate price at which the shares should be issued. There are two ways in which the price of an IPO can be determined: either the company, with the help of its lead managers, fixes a price or the price is arrived at through the process of book building.

There are two time windows commonly referred to as “quiet periods” during an IPO's history. The first and the one linked above is the period of time following the filing of the company's S-1 but before SEC staff declare the registration statement effective. During this time, issuers, company insiders, analysts, and other parties are legally restricted in their ability to discuss or promote the upcoming IPO.

The other “quiet period” refers to a period of 40 calendar days following an IPO's first day of public trading. During this time, insiders and any underwriters involved in the IPO, are restricted from issuing any earnings forecasts or research reports for the company. Regulatory changes enacted by the SEC as part of the Global Settlement, enlarged the “quiet period” from 25 days to 40 days on Jul. 9, 2002. When the quiet period is over, generally the lead underwriters will initiate research coverage on the firm. Additionally, the NASDAQ (National Association of Dealers Automated Quotations) and NYSE (New York Stock Exchange) have approved a rule mandating a 10-day quiet period after a Secondary Offering and a 15-day quiet period both before and after expiration of a “lock-up agreement” for a securities offering.

Once the Member/Producer of the Social Network Service has cleared vetting and has received SEC approval the production company will be listed on the Alternative Trading System connected to the Electronic Communication Networks.

Alternative Trading Systems (ATS) are SEC-approved non-exchange trading venues. They play an important role in public markets for allowing alternative means of accessing liquidity.

Rule 300(a) of the SEC's regulation ATS provides the following legal definition of an “alternative trading system”:

Any organization, association, person, group or persons, or system:

That constitutes, maintains, or provides a market place or facilities for bringing together purchasers and sellers of securities or for otherwise performing with respect to securities the functions commonly performed by a stock exchange within the meaning of Rule 3b-16 of this chapter.

The Member/Producer's company employing the Social Network Service is now ready for it's IPO to take place. The Member/Producer's company that is listed on the Alternative Trading System will after the quit period, begin selling equity shares in their production company to the public Member/Investors. The two parties will engage in trading shares through Electronic Communication Networks.

Electronic Communication Networks or ECN's as defined in rule 600(b) (23) of regulation NMS, are electronic trading systems that automatically match buy and sell orders at specified prices. ECN's register with the SEC as broker-dealers and are subject to regulation ATS.

An Electronic Communication Networks (ECN) is the term used in financial circles for a type of computer system that facilitates trading of financial products outside of stock markets. The primary products that are traded on ECNs are stocks and currencies. ECNs came into existence in 1998 when the SEC authorized their creation. ECNs increase competition among trading firms by lowering transaction costs, giving clients full access to their order books, and offering order matching outside of traditional exchange hours.

In order to trade with an ECN, one must be a subscriber or have an account with a broker that provides direct access trading. ECN subscribers can enter orders into the ECN via a custom computer terminal or network protocols. The ECN will then match contra-side orders (i.e. a sell-order is “contra-side” to a buy-order with the same price and share count) for execution. The ECN will post unmatched orders on the system for other subscribers to view. Generally, the buyer and seller are anonymous, with the trade execution reports listing the ECN as the party.

Some ECNs may offer additional features to subscribers such as negotiation, reserve size, and pegging, and may have access to the entire ECN book (as opposed to the “top of the book”) that contains important real-time market data regarding depth of trading interest.

For stock, ECNs exist as a class of SEC-permitted Alternative Trading Systems (ATS). As an ATS, ECNs exclude broker-dealers' internal cross networks—i.e., systems that match orders at the broker-dealer using prices from an exchange, without actually sending the order to a public venue.

ECN's fee structure can be grouped in two basic structures: a classic structure and a credit (or rebate) structure. Both fee structures offer advantages of their own. The classic structure tends to attract liquidity removers while the credit structure appeals to liquidity providers.

In a credit structure ECNs make a profit from paying liquidity providers a credit while charging a debit to liquidity removers. Their fees range from $0.002 to $0.0027 per share for liquidity providers and $0.003 to $0.0025 per share for liquidity removers. The fee can be determined by monthly volume provided and removed, or by a fixed structure, depending on the ECN, and it's known as a liquidity rebate, or credit. This structure is common on the NASDAQ (National Association of Dealers Automated Quotations) market. In a classic structure, the ECN will charge a small fee to all market participants using their network, both liquidity providers and removers. They can also give lower prices to large liquidity providers in order to attract volume to their networks. Fees for ECNs that operate under a classic structure range from $0 to $0.0015, or even higher depending on each ECN. This fee structure is more common in the NYSE (New York Stock Exchange), however recently some ECNs have moved their NYSE operations into a credit structure.

Once the Member/Producer has been listed on the ATS and has placed 100% of the equity shares of their production company thru to the Member/Investors they will need to purchase a completion bond to proceed with the financial transactions.

A Completion bond is a surety bond issued by an insurance company or a bank to guarantee satisfactory completion of a project by a contractor.

For example, a contractor may cause a performance bond to be issued in favor of a client for whom the contractor is constructing a building. If the contractor fails to construct the building according to the specifications laid out by the contract (most often due to the bankruptcy of the contractor), the client is guaranteed compensation for any monetary loss up to the amount of the performance bond.

Performance bonds are commonly used in the construction and development of real property, where an owner or investor may require the developer to assure that contractors or project managers procure such bonds in order to guarantee that the value of the work will not be lost in the case of an unfortunate event (such as insolvency of the contractor). In other cases a performance bond may be requested to be issued in other large contracts besides civil construction projects.

The term is also used to denote a collateral deposit intended to secure a future contract, commonly known as margin.

Performance bonds are generally issued as part of a ‘Performance and Payment Bond’, where a Payment Bond guarantees that the contractor will pay the labour and material costs they are obliged to.

Performance bonds have been around since 2,750 BC and, more recently, the Romans developed laws of surety around 150 AD, the principles of which still exist.

With a satisfactory purchase of a Completion Bond by the Member/Producer for their media project the Producer will be given a green light.

To Green Light a project is to give permission or a go ahead to move forward with a project. In the context of the movie and TV businesses, to green light something is to formally approve its production finance, thereby allowing the project to move forward from the development phase to pre-production and principal photography.

The term is a reference to the green traffic signal, indicating “go ahead.”

The power to green light a project is generally reserved to those in a project or financial management role within an organization. The process of taking a project from pitch to green light formed the basis of a successful reality TV show titled Project Green Light. The term has found its way into general business and military culture as a result of its use in the film industry.

Once the green light has been given the Member/Producer can create the media product that they have raised funds for through the IPO process on the Social Network Service Alternative Trading System and Electronic Communication Networks.

In Filmmaking the process of making a film, from an initial story idea or commission through scriptwriting, shooting, editing and finally distribution to an audience. Typically it involves a large number of people and can take anywhere between a few months to several years to complete. Filmmaking takes place all over the world in a huge range of economic, social and political contexts, using a variety of technologies and techniques.

This is the stage where an idea is fleshed out into a viable script. The producer of the movie will find a story, which may come from books, plays, other films, true stories, original ideas, etc. Once the theme, or underlying message, has been identified, a synopsis will be prepared. This is followed by a step outline, which breaks the story down into one-paragraph scenes, concentrating on the dramatic structure. Next, a treatment is prepared. This is a 25 to 30 page description of the story, its mood and characters, with little dialog and stage direction, often containing drawings to help visualize the key points.

The screenplay is then written over a period of several months, and may be rewritten several times to improve the dramatization, clarity, structure, characters, dialogue, and overall style. However, producers often skip the previous steps and develop submitted screenplays which are assessed through a process called script coverage. A film should be contacted at an early stage to assess the likely market and potential financial success of the film. Hollywood distributors will adopt a hard-headed business approach and consider factors such as the film genre, the target audience, the historical success of similar films, the actors who might appear in the film and the potential directors of the film. All these factors imply a certain appeal of the film to a possible audience and hence the number of “burns on seats” during the theatrical release. Not all films make a profit from the theatrical release alone, therefore DVD sales and worldwide distribution rights need to be taken into account.

The movie pitch, or treatment, is then prepared and presented to potential financiers. If the pitch is successful and the movie is given the “green light”, then financial backing is offered, typically from a major film studio, film council or independent investors. A deal is negotiated and contracts are signed.

In pre-production, the movie is designed and planned. The production company is created and a production office established. The production is story boarded and visualized with the help of illustrators and concept artists. A production budget will also be drawn up to cost the film.

The producer will hire a crew. The nature of the film, and the budget, determine the size and type of crew used during filmmaking. Many Hollywood blockbusters employ a cast and crew of hundreds, while a low-budget independent film may be made by a skeleton crew of eight or nine (or less). Typical crew positions include:
The director is primarily responsible for the acting in the movie and managing the creative elements.
The assistant director (AD) manages the shooting schedule and logistics of the production, among other tasks. First AD and second AD are different jobs with different responsibilities.
The casting director finds actors for the parts in the script. This normally requires an audition by the actor. Lead actors are carefully chosen and are often based on the actor's reputation or “star power.”
The location manager finds and manages the film locations. Most pictures are shot in the predictable environment of a studio sound stage but occasionally outdoor sequences will call for filming on location.
The production manager manages the production budget and production schedule. He or she also reports on behalf of the production office to the studio executives or financiers of the film.
The director of photography (DP or DOP) or cinematographer creates the photography of the film. He or she cooperates with the director, director of audiography (DOA) and AD.
The production designer creates the look and feel of the production sets and props, working with the art director to create these elements.
The art director manages the art department, which makes production sets
The costume designer creates the clothing for the characters in the film working closely with the actors, as well as other departments.
The make up and hair designer works closely with the costume designer in addition to create a certain look for a character.
The storyboard artist creates visual images to help the director and production designer communicate their ideas to the production team.
The production sound mixer is the head of the sound department during the production stage of a film. He or she records and mixes the audio (dialogue and occasional effects) on the set. He or she works with the director, DOP, and 1st AD.
The sound designer creates new sounds and enhances the aural feel of the film with the help of foley artists.
The composer creates new music for the film.
The choreographer creates and coordinates the movement and dance—typically for musicals. Some films also credit a fight choreographer.

In production the movie is created and shot. More crew will be recruited at this stage, such as the property master, script supervisor, assistant directors, stills photographer, picture editor, and sound editors. These are just the most common roles in filmmaking; the production office will be free to create any unique blend of roles to suit a particular film.

A typical day's shooting begins with the crew arriving on the set/location by their call time. Actors usually have their own separate call times. Since set construction, dressing and lighting can take many hours or even days, they are often set up in advance. The grip, electric and production design crews are typically a step ahead of the camera and sound departments: for efficiency's sake, while a scene is being filmed, they are already preparing the next one.

While the crew prepare their equipment, the actors are wardrobed in their costumes and attend the hair and make-up departments. The actors rehearse the script and blocking with the director and the camera and sound crews rehearse with them and make final tweaks. Finally, the action is shot in as many takes as the director wishes. Most American productions follow a specific procedure:

The assistant director calls “picture is up!” to inform everyone that a take is about to be recorded, and then “quiet, everyone!” Once everyone is ready to shoot, he calls “roll sound” (if the take involves sound), and the sound recordist will start her equipment, record a verbal notification of the take's information, and announce “sound speeds” when he is ready. The AD follows by “roll camera”, answered by “speed!” once the camera is recording. The clapper, who is already in front of the camera with the clapper board, calls “marker!” and slaps it shut. If the take involves extras or background action, the AD will cue them (“action background!”), and last is the director, telling the actors “action!”.

A take is over when the director calls “cut!”, and camera and sound stop recording. The script supervisor will note any continuity issues and the sound and camera teams log technical notes for the take on their respective report sheets. If the director decides additional takes are required, the whole process repeats. Once satisfied, the crew moves on to the next camera angle or “setup,” until the whole scene is “covered.” When shooting is finished for the scene, the assistant director declares a “wrap” or “moving on,” and the crew will “strike,” or dismantle, the set for that scene.

At the end of the day, the director approves the next day's shooting schedule and a daily progress report is sent to the production office. This includes the report sheets from continuity, sound, and camera teams. Call sheets are distributed to the cast and crew to tell them when and where to turn up the next shooting day. Later on, the director, producer, other department heads, and, sometimes, the cast, may gather to watch that day or yesterday's footage, called dailies, and review their work.

With workdays often lasting 14 or 18 hours in remote locations, film production tends to create a team spirit. When the entire film is in the can, or in the completion of the production phase, it is customary for the production office to arrange a wrap party, to thank all the cast and crew for their efforts.

Here the film is assembled by the film editor. The modern use of video in the filmmaking process has resulted in two workflow variants: one using entirely film, and the other using a mixture of film and video.

In the film workflow, the original camera film (negative) is developed and copied to a one-light workprint (positive) for editing with a mechanical editing machine. An edge code is recorded onto film to locate the position of picture frames. Since the development of non-linear editing systems such as Avid, Quantel or Final Cut Pro, the film workflow is used by very few productions.

In the video workflow, the original camera negative is developed and telecined to video for editing with computer editing software. A time code is recorded onto video tape to locate the position of picture frames. Production sound is also synced up to the video picture frames during this process.

The first job of the film editor is to build a rough cut taken from sequences (or scenes) based on individual “takes” (shots). The purpose of the rough cut is to select and order the best shots. The next step is to create a fine cut by getting all the shots to flow smoothly in a seamless story. Trimming, the process of shortening scenes by a few minutes, seconds, or even frames, is done during this phase. After the fine cut has been screened and approved by the director and producer, the picture is “locked,” meaning no further changes are made. Next, the editor creates a negative cut list (using edge code) or an edit decision list (using time code) either manually or automatically. These edit lists identify the source and the picture frame of each shot in the fine cut.

Once the picture is locked, the film passes out of the hands of the editor to the sound department to build up the sound track. The voice recordings are synchronized and the final sound mix is created. The sound mix combines sound effects, background sounds, ADR, dialogue, walla, and music.

The sound track and picture are combined together, resulting in a low quality answer print of the movie. There are now two possible workflows to create the high quality release print depending on the recording medium:
In the film workflow, the cut list that describes the film-based answer print is used to cut the original color negative (OCN) and create a color timed copy called the color master positive or inter positive print. For all subsequent steps this effectively becomes the master copy. The next step is to create a one-light copy called the color duplicate negative or inter negative. It is from this that many copies of the final theatrical release print are made. Copying from the inter negative is much simpler than copying from the inter positive directly because it is a one-light process; it also reduces wear-and-tear on the inter-positive print.
   1. In the video workflow, the edit decision list that describes the video-based answer print is used to edit the original color tape (OCT) and create a high quality color master tape. For all subsequent steps this effectively becomes the master copy. The next step uses a film recorder to read the color master tape and copy each video frame directly to film to create the final theatrical release print.

Finally the film is previewed, normally by the target audience, and any feedback may result in further shooting or edits to the film.

This is the final stage, where the movie is released to cinemas or, occasionally, to DVD, VCD, (though VHS tapes are less common now that more people own DVD players), Blue-Ray, or direct download from a provider. The movie is duplicated as required for distribution to theaters. Press kits, posters, and other advertising materials are published and the movie is advertised.

The movie will usually be launched with a launch party, press releases, interviews with the press, showings of the film at a press preview, and/or at film festivals. It is also common to create a website to accompany the movie. The movie will play at selected cinemas and the DVD is typically released a few months later. The distribution rights for the film and DVD are also usually sold for worldwide distribution. Any profits are divided between the distributor and the production company.

Filmmaking also takes place outside of the studio system and is commonly called independent filmmaking. Since the introduction of DV technology, the means of production have become more democratized. Filmmakers can conceivably shoot and edit a movie, create and edit the sound and music, and mix the final cut on a home computer. However, while the means of production may be democratized, financing, distribution, and marketing remain difficult to accomplish outside the traditional system. Most independent filmmakers rely on film festivals to get their films noticed and sold for distribution. However, the Internet has allowed for relatively inexpensive distribution of independent films; many filmmakers post their films online for critique and recognition. Although there is little profitability in this, a filmmaker can still gain exposure via the web.

Upon completion of the Member/Producers media project the e.g. film the product will be sold. A film distributor is an independent company, a subsidiary company or occasionally an individual, which acts as the final agent between a film production company or some intermediary agent, and a film exhibitor, to the end of securing placement of the producer's film on the exhibitor's screen. In the film business, the term “distribution” refers to the marketing and circulation of movies in theaters, and for home viewing (DVD, Video-On-Demand, Download, Television etc).

The primary agenda of the distributor is to convince the exhibitor to rent, or “book”, each film. To this end the distributor usually arranges industry screenings for exhibitors, and uses other marketing techniques that will make the exhibitor believe they will profit financially by showing the film.

Once this is accomplished, the distributor then secures a written contract stipulating the amount of the gross ticket sales to be paid to the distributor (usually a percentage of the gross after first deducting a “floor”, which is called a “house allowance” (also known as the “nut”), collect the amount due, audit the exhibitor's ticket sales as necessary to ensure the gross reported by the exhibitor is accurate, secure the distributor's share of these proceeds, and transmit the remainder to the production company (or to any other intermediary, such as a film release agent). Ordinarily there are standard blanket contracts between a distributor and an exhibitor that apply to all films subsequently booked, although on occasion some of the terms, such as the percentage of the gross to be paid by the exhibitor, may be varied with regard to a particular film.

The distributor must also ensure that enough film prints are struck to service all contracted exhibitors on the contract-based opening day, ensure their physical delivery to the theater by the opening day, monitor exhibitors to make sure the film is in fact shown in the particular theatre with the minimum number of seats and show times, and ensure the prints' return to the distributor's office or other storage resource also on the contract-based return date. In practical terms, this includes the physical production of film prints and their shipping around the world (a process that is beginning to be replaced by digital distribution) as well as the creation of posters, newspaper and magazine advertisements, television commercials, trailers, and other types of ads.

Furthermore, the distributor is responsible for ensuring a full line of film advertising material is available on each film which it believes will help the exhibitor attract the largest possible audience, create such advertising if it is not provided by the production company, and arrange for the physical delivery of the advertising items selected by the exhibitor at intervals prior to the opening day.

If the distributor is handling an imported or foreign-language film, it may also be responsible for securing dubbing or subtitling for the film, and securing censorship or other legal or organizational “approval” for the exhibition of the film in the country/territory in which it does business, prior to approaching the exhibitors for booking.

In the days of the classical Hollywood cinema, the studios used the studio system, producing and distributing their own films to theaters that they also owned—a practice known as vertical integration. The studios' control over distribution was greatly weakened in the U.S. when, in 1948, the court case United States v. Paramount Pictures, Inc. forced the major film studios to sell all their theaters. Today, major studios and independent production companies alike compete for screens in theaters.

When the Member/Producer releases his media project for sale a notification will be sent out to the Member/Investors of the project. They will be informed by e-mail and other communication methods that the Production is being sold.

A modern notification system is a combination of software and hardware that provides a means of delivering a message to a set of recipients. For example, notification systems can send an e-mail when a new topic has been added to Wikipedia. The complexity of the notification system is often dependent on the types of messages that must be sent. An e-mail noting when a page has been inserted into Wikipedia is adequate for such a straightforward task. However, notifying individuals when a building is on fire would require real-time interaction, escalation, scheduling, rosters, and fail-over scenarios.

The number of ways a person can interact with technology has steadily increased. Advanced notification systems support at least one and sometimes all of the following communications media:
Text Messaging (SMS)
Voice (telephone, cell phone, VoIP, outdoor loudspeaker, indoor PA system)
E-mail (POP, IMAP, SMTP)
Desktop alert (PC, Mac)
Pager (SNPP)
Instant Messaging (AIM, Jabber, MSN, ICQ)
RSS (RSS reader, digital signage)
Web page (Javascript, XML)
Fax

Notification systems are used throughout the following industries:
Financial institutions (banks, stock brokers, credit unions)
Emergency services (police, fire department, ambulance)
Manufacturing (computer hardware, motorcycles, television)
Information technology (help desk, networks, software monitors)
Weather (storms, earthquake, tsunami)
Government
Education

When the Member/Producers media project becomes profitable it will begin the process of distributing the profits in the form of Dividends of the venture to its shareholders.

Dividends are payments made by a corporation to its shareholder members. It is the portion of corporate profits paid out to stockholders. When a corporation earns a profit or surplus, that money can be put to two uses: it can either be re-invested in the business (called retained earnings), or it can be paid to the shareholders as a dividend. Many corporations retain a portion of their earnings and pay the remainder as a dividend.

For a joint stock company, a dividend is allocated fast as a fixed amount per share. Therefore, a shareholder receives a dividend in proportion to their shareholding. For the joint stock company, paying dividends is not an expense; rather, it is the division of an asset among shareholders. Public companies usually pay dividends on a fixed schedule, but may declare a dividend at any time, sometimes called a special dividend to distinguish it from a regular one.

Cooperatives, on the other hand, allocate dividends according to members' activity, so their dividends are often considered to be a pre-tax expense.

Dividends are usually settled on a cash basis, as a payment from the company to the shareholder. They can take other forms, such as store credits (common among retail consumers' cooperatives) and shares in the company (either newly-created shares or existing shares bought in the market.) Further, many public companies offer dividend reinvestment plans, which automatically use the cash dividend to purchase additional shares for the shareholder.

Cash dividends (most common) are those paid out in the form of a check. Such dividends are a form of investment income and are usually taxable to the recipient in the year they are paid. This is the most common method of sharing corporate profits with the shareholders of the company.

For each share owned, a declared amount of money is distributed. Thus, if a person owns 100 shares and the cash dividend is $0.50 per share, they will receive $50.00 in total.

Stock or scrip dividends are those paid out in form of additional stock shares of the issuing corporation, or other corporation (such as its subsidiary corporation). They are usually issued in proportion to shares owned (for example, for every 100 shares of stock owned, 5% stock dividend will yield 5 extra shares). If this payment involves the issue of new shares, this is very similar to a stock split in that it increases the total number of shares while lowering the price of each share and does not change the market capitalization or the total value of the shares held (see also Stock dilution).

Property dividends or dividends in specie (Latin for “in kind”) are those paid out in the form of assets from the issuing corporation or another corporation, such as a subsidiary corporation. They are relatively rare and most frequently are securities of other companies owned by the issuer, however they can take other forms, such as products and services.

Dividends can be used in structured finance. Financial assets with a known market value can be distributed as dividends; warrants are sometimes distributed in this way.

For large companies with subsidiaries, dividends can take the form of shares in a subsidiary company. A common technique for “spinning off” a company from its parent is to distribute shares in the new company to the old company's shareholders. The new shares can then be traded independently.

Dividends must be “declared” (approved) by a company's Board of Directors each time they are paid. For public companies, there are four important dates to remember regarding dividends. These are discussed in detail with examples at the Securities and Exchange Commission site.

The declaration date is the day the Board of Directors announces its intention to pay a dividend. On this day, a liability is created and the company records that liability on its books; it now owes the money to the stockholders. On the declaration date, the Board will also announce a date of record and a payment date.

This is the last day, which is one trading day before the ex-dividend date, where the stock is said to be cum dividend (‘with [including] dividend’). In other words, existing holders of the stock and anyone who buys it on this day will receive the dividend, whereas any holders selling the stock lose their right to the dividend. After this date the stock becomes ex dividend.

The ex-dividend date (typically 2 trading days before the record date for U.S. securities) is the day on which all shares bought and sold no longer come attached with the right to be paid the most recently declared dividend. This is an important date for any company that has many stockholders, including those that trade on exchanges, as it makes reconciliation of who is to be paid the dividend easier. Existing holders of the stock will receive the dividend even if they now sell the stock, whereas anyone who now buys the stock will not receive the dividend.

It is relatively common for a stock's price to decrease on the ex-dividend date by an amount roughly equal to the dividend paid. This reflects the decrease in the company's assets resulting from the declaration of the dividend. The company does not take any explicit action to adjust its stock price; in an efficient market, buyers and sellers will automatically price this in.

Shareholders who properly registered their ownership on or before the date of record will receive the dividend. Shareholders who are not registered as of this date will not receive the dividend. Registration in most countries is essentially automatic for shares purchased before the ex-dividend date.

The payment date is the day when the dividend checks will actually be mailed to the shareholders of a company or credited to brokerage accounts.

Some companies have dividend reinvestment plans, or DRIPs. These plans allow shareholders to use dividends to systematically buy small amounts of stock, usually with no commission and sometimes at a slight discount. In some cases the shareholder might not need to pay taxes on these re-invested dividends, but in most cases they do.

After the Member/Producers media production has completed its IPO, created the media project, brought it to market for sale and passes the lock-up period Member/Investors of the Social Network Service can proceed with secondary trading on the Alternative Trading System and Electronic Communication Networks.

The secondary market, also known as the aftermarket, is the financial market where previously issued securities and financial instruments such as stock, bonds, options, and futures are bought and sold. The term “secondary market” is also used refer to the market for any used goods or assets, or an alternative use for an existing product or asset where the customer base is the second market (for example, corn has been traditionally used primarily for food production and feedstock, but a second- or third-market has developed for use in ethanol production).

With primary issuances of securities or financial instruments, or the primary market, investors purchase these securities directly from issuers such as corporations issuing shares in an IPO or private placement, or directly from the federal government in the case of treasuries. After the initial issuance, investors can purchase from other investors in the secondary market.

The secondary market for a variety of assets can vary from fragmented to centralized, and from illiquid to very liquid. The major stock exchanges are the most visible example of liquid secondary markets—in this case, for stocks of publicly traded companies. Exchanges such as the New York Stock Exchange, NASDAQ and the American Stock Exchange provide a centralized, liquid secondary market for the investors who own stocks that trade on those exchanges. Most bonds and structured products trade “over the counter,” or by phoning the bond desk of one's broker-dealer.

Secondary marketing is vital to an efficient and modern capital market. In the secondary market, securities are sold by and transferred from one investor or speculator to another. It is therefore important that the secondary market be highly liquid (originally, the only way to create this liquidity was for investors and speculators to meet at a fixed place regularly; this is how stock exchanges originated. As a general rule, the greater the number of investors that participate in a given marketplace, and the greater the centralization of that marketplace, the more liquid the market.

Fundamentally, secondary markets mesh the investor's preference for liquidity (i.e., the investor's desire not to tie up his or her money for a long period of time, in case the investor needs it to deal with unforeseen circumstances) with the capital user's preference to be able to use the capital for an extended period of time.

The term may refer to markets in things of value other than securities. For example, the ability to buy and sell intellectual property such as patents, or rights to musical compositions, is considered a secondary market because it allows the owner to freely resell property entitlements issued by the government. Similarly, secondary markets can be said to exist in some real estate contexts as well (e.g. ownership shares of time-share vacation homes are bought and sold outside of the official exchange set up by the time-share issuers). These have very similar functions as secondary stock and bond markets in allowing for speculation, providing liquidity, and financing through securitization.

Partially due to increased compliance and reporting obligations enacted in the Sarbanes-Oxley Act of 2002, private secondary markets began to emerge. These markets are generally only available to institutional or accredited investors and allow trading of unregistered and private company securities.

In private equity, the secondary market (also often called private equity secondaries or secondaries) refers to the buying and selling of pre-existing investor commitments to private equity funds. Sellers of private equity investments sell not only the investments in the fund but also their remaining unfunded commitments to the funds.

The Members will always have access to the Social Network Service, Alternative Trading System and Electronic Communication Networks so that they may do all the business that they decide to do. After the members have accomplished their goals they are free to go back to the SNS, ATS and ECN's and continue to buy and sell existing and/or new products offered by Member/Producers.

### Alternative Embodiments

There are various possibilities to using the Social Network Service, Alternative Trading System and Electronic Communication Networks. Members may wish to use the Alternative Trading System and forego the Social Networking so that they can focus on trading equity stocks that are being sold on the Alternative Trading System and Electronic Communication Networks. If this is the case the Member can jump straight to the ATS and ECNs.

Another form of the embodiments could have the member focus their attention on the social aspects of the website while still being able to accomplish the same financial goals if they so choose.

Still other embodiments could take the form of just following the stocks on the Alternative Trading System and the Electronic Communication Networks.

It is up to the member to use the Social Network Service, Alternative Trading System and Electronic Communication Network the way they decide best suits them.

### Conclusions, Ramifications and Scope

From the description above, a number of advantages of some embodiments of my Method and System combining a Social Network Service with an Alternative Trading System and Electronic Communications Network to produce entertainment media become evident.

The major studio/distributors in Hollywood, divisions of the major global media conglomerates (NBC Universal, Sony, Viacom/CBS, Disney/ABC, Time Warner Bros., News Corp/Fox) supply over 90% of media content to the U.S.A thru monopolistic control of the media industry by employing the Cartel (a formal organization of producers that agree to coordinate prices and production) like use of unfair, unethical, anti-competitive, predatory and illegal business practices, including provisions in the distribution deal between film distributors and producers. These unconscionable and some say illegal business practices are used to control a majority of the media industry to the detriment of the United States because the majority of the ideas produced in Hollywood are self-serving corporate visions used to maintain control of this vital medium for the exchange of information. A free and open society depends on a myriad of views to remain a growing democracy.

The combination of a Social Network Service (SNS), Alternative Trading System (ATS) and Electronic Communication Networks (ECN) are a method and/or system that enable's independent producers of entertainment media to readily find the capital that they require to create their art and distribute it through established and future distribution models. By so doing a major barrier to entry into the media industry has been removed. By using the combined SNS, ATS and ECN, independent producers of entertainment media can have their voices heard by society enabling a more diverse and democratic America to emerge.

Using the application, more and perhaps better media content can be created by independent producers and distributed thru the Internet (Netflix, iTunes, Amazon, YouTube, Wal-Mart and other online and physical outlets) as well as traditional venues. By enabling independent, professionally produced, content to be created, a well rounded view of our world can be had that will benefit every person in our society because it adds to the public good that should be protected in our democracy.

By creating and combining a Social Network Service, Alternative Trading System, and Electronic Communication Networks that has listing requirements, SEC regulations and fees that are tailored to the needs of independent producers of entertainment media vs. the extremely expensive and regulatory prohibitive stock exchanges like the NYSE (New York Stock Exchange) or the NASDAQ (National Association of Securities Dealers Automated Quotations), gives independent producers and investors a capital market not known to them before.

By combining a Social Network Service, Alternative Trading System and Electronic Communication Networks where producers can easily find readily available capital will enable a multitude of producers of entertainment media to take advantage of the application and by so doing will create a new independent Hollywood system that can rival and even surpass the old Hollywood studio system. In Hollywood, the people who have the capital make the rules as far as the way they work, so a producer using the application can create their art the way they envision it.

Combination of a Social Network Service with an Alternative Trading System and Electronic Communication Networks will also enable investors who have received less compensation than they could have received from the major media conglomerates stock, which is being manipulated thru the insider production and distribution deal's of Hollywood's major studio/distributors, to get their fair share of the rewards of investing in entertainment media and mediums.

Members will have a great resource for use in raising financial capital, buying and trading stocks and/or use of the social side of the website. By using various embodiments the independent producer can achieve their goal of getting funding to green light their project and create their art and investors can get a better return on investment than they had previously.

While my above description contains many specificities, these should not be looked at as limitations on the scope, but rather as an exemplification of one [or several] preferred embodiment there of. Many other variations are possible. For example members using the website for social activities not related to trading stock.

I claim:

1. A method for financing entertainment media production companies comprising:
a) social network service providing a way for member/producers and member/investors to form communities in order to produce and invest in entertainment media companies,
b) alternative trading system enabling member/producers and member/investors using the social network service thru internet enabled digital devices to list, quote, buy, sell and trade in initial public offerings and/or secondary trading of equity shares of entertainment media companies,
c) electronic communication networks that match buy/sell orders of entertainment media companies selling equity stocks with investors purchasing said stocks.

2. A method providing a social network service to bring together companies that produce entertainment media with investors that want to purchase equity stocks of entertainment media companies comprising:
a) website enabling producers of entertainment media products to meet investors interested in purchasing entertainment media companies equity shares,
b) alternative trading system that enables producers to list, sell and buy equity stock in entertainment media companies to investors interested in purchasing said equity stocks of entertainment media companies,
c) electronic communication networks that match buy/sell orders between entertainment media companies selling equity stocks and investors interested in purchasing said entertainment media companies equity stocks.

3. A method of selling and investing in entertainment media companies using an alternative trading system comprising:
a) social network service enabling sellers and investors of entertainment media companies to come together to sell, buy and trade equity stocks of said entertainment media companies,
b) electronic communication networks that match buy/sell orders of entertainment media companies equity stocks with investors who purchase said stocks.
